(19) United States
(12) Patent Application Publication
(10) Pub. No.: US 2022/0372212 A1
(43) Pub. Date: Nov. 24, 2022

(54) TRIBLOCK COPOLYMERS AND HYDROGELS THEREOF

(71) Applicant: The Governors of the University of Alberta, Edmonton (CA)

(72) Inventors: Nasim GHASEMI, Edmonton (CA); Mohammad Reza VAKILI, Edmonton (CA); Afsaneh LAVASANIFAR, Edmonton (CA)

(73) Assignee: The Governors of the University of Alberta, Edmonton (CA)

(21) Appl. No.: 17/732,635

(22) Filed: Apr. 29, 2022

Related U.S. Application Data
(60) Provisional application No. 63/182,422, filed on Apr. 30, 2021.

(51) Int. Cl. C08G 63/08; C08G 63/78; C08J 3/075; C08F 299/04; C08J 3/24

(52) U.S. Cl. CPC C08G 63/08; C08G 63/78; C08J 3/075; C08F 299/0407; C08J 3/24

(57) ABSTRACT

The invention provides methods for the formation of thermo-reversible hydrogels from triblock copolymers of poly(ethylene glycol) and poly(α-benzyl carboxylate-ε-caprolactone) (PBCL-PEG-PBCL) prepared by bulk and solution polymerization. PBCL-PEG-PBCLs prepared at fixed PBCL to PEG ratios but different polymerization times were characterized for their average molecular weights, molar-mass disparity and intrinsic viscosity using ¹H NMR and gel permeation chromatography (GPC). The results indicated a copolymer of high molecular weight population with elevated intrinsic viscosity. The size and proportion of this population grew as a function of polymerization time. The formation of this high molecular weight PBCL-PEG-PBCL population can be attributed to non-linear architecture caused by partial cross-linking of the PBCL segment during the polymerization reaction. At least about 40% mole concentration of the high molecular weight PBCL-PEG-PBCL was required for thermo-reversible micellar aggregation in aqueous media and hydrogel formation.

### RELATED APPLICATIONS

This application claims priority under 35 U.S.C. § 119(e) to U.S. Provisional Patent Application No. 63/182,422 filed Apr. 30, 2021, which is incorporated herein by reference.

### BACKGROUND OF THE INVENTION

Thermo-gelling polymers, i.e., those forming aqueous colloidal dispersions or sol at low temperature, but turn to gel at higher temperatures, have been the focus of much interest in biomedical fields particularly for drug delivery and tissue engineering applications. In this context, polyester based thermo-gels have great potential, owing to their biodegradability at physiological conditions and biocompatibility of their degradation products. Polyesters such as block copolymers of poly(D, L-lactide-co-glycolide)-b-poly(ethylene glycol)-b-poly(D,L-lactide-co-glycolide) (PLGA-PEG-PLGA), known as ReGel®, and poly(ε-caprolactone)-b-poly(ethylene glycol)-b-poly(ε-caprolactone) (PCL-PEG-PCL) exhibit reversible sol-gel transition around physiological temperature in aqueous media.

Despite the development of several thermo-gelling polyester-based biomaterials, prior reports on polymeric characteristics that can affect their thermo-responsive gelation and their viscoelastic properties are scarce. Nevertheless, a role for the chemical structure, molecular weight, molecular weight distribution (MWD) and hydrophilic/hydrophobic block length of PEG-poly(ester) block copolymers on their thermo-gelling behaviour is implicated. One of the few studies on this subject has been conducted by Ding et al who examined the influence of molar-mass disparity (Ð_{M}) of ReGel®, on its sol-gel transition temperature (T_{gel}) in aqueous media. They found a positive correlation between Ð_{M} and transition temperature of ReGel®, irrespective of the average molecular weight of the PLGA-PEG-PLGA polymers (Macromolecules 2014; 47(17):5895-5903). However, the source of an increase in the Ð_{M} of the polymer or processing conditions that can affect the Ð_{M} and, in turn, control the thermoresponsive sol-gel transition of ReGel® has not been clarified.

Accordingly, there is a need for new biodegradable triblock copolymers, thermo-reversible hydrogels, and thermo-gelling polymers with enhanced viscoelastic properties.

### SUMMARY

The invention provides thermo-reversible hydrogels, and methods of preparing thermo-reversible hydrogels. The hydrogels can include triblock copolymers, for example, triblock copolymers based on poly(α-benzyl carboxylate-ε-caprolactone) and poly(ethylene glycol).

Our research group has previously reported on the synthesis of biodegradable triblock copolymers based on PEG, as the hydrophilic middle block, and a-benzyl carboxylate substituted PCL, as the hydrophobic lateral blocks (abbreviated as PBCL-PEG-PBCL) using bulk ring opening polymerization (Pharm Res 2016; 33(2):358-366). The objective of the current research was to investigate the synthesis conditions and/or polymer characteristics that can lead to the production of thermo-gelling PBCL-PEG-PBCLs with enhanced viscoelastic properties. In this context, using a fixed monomer to initiator molar ratio, we first assessed the effect of polymerization time in bulk versus solution ring opening polymerization, on the characteristics of the synthesized PBCL-PEG-PBCL block copolymers in terms of average molecular weights, molar-mass disparity ÐM and intrinsic viscosity. In the second step, the thermo-responsive self-assembly, gelation and rheology of block copolymer solutions in aqueous media were investigated. Our results revealed that the formation of thermo-reversible PBCL-PEG-PBCL hydrogels to be dependent on the existence of a polymer population with a higher-than-expected average molecular weight at about at least 40% molar concentration of the block copolymer sample, irrespective of the polymerization method. Solution polymerization enabled better control over the weight percentage of partially cross-linked PBCL-PEG-PBCL, under current synthesis conditions.

Accordingly, this disclosure provides copolymers represented by Formula I:

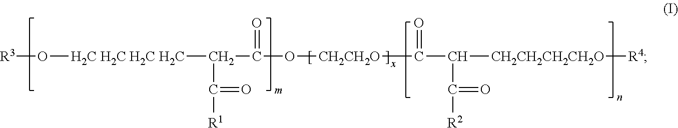

wherein

R¹ and R² are each independently a crosslinker, —OH, —O(C₁-C₆)alkyl, or —OCH₂Ph wherein Ph is optionally substituted;

R³ and R⁴ are terminal groups;

m and n are each independently an integer from 1-50; and x is an integer from 5-150.

Also, this disclosure provides a method for forming the above copolymer according comprising contacting benzyl 2-oxooxepane-3-carboxylate and polyethylene glycol for a sufficient period of time at above 25° C. to form a copolymer under ring-opening polymerization reaction conditions, wherein optionally the method further comprises at least partially debenzylating the copolymer and crosslinking the at least partially debenzylated copolymer with a crosslinker that comprises at least two primary alcohols.

### BRIEF DESCRIPTION OF THE DRAWINGS

The drawings and figures shown herein form part of the specification and are included to further demonstrate certain embodiments or various aspects of the invention. In some instances, embodiments of the invention can be best understood by referring to the accompanying figures in combination with the detailed description presented herein. The description and accompanying figures may highlight a certain specific example, or a certain aspect of the invention. However, one skilled in the art will understand that portions of the example or aspect may be used in combination with other examples or aspects of the invention described herein.

FIG. 1.1. 1H NMR spectrum of PBCL-PEG-PBCL block copolymers (B₀ and S₀) in CDCl3 and peak assignments.

FIG. 1.2. The effect of polymerization times on the A) Degree of polymerization; B) Mₙ as measured by ¹H NMR; C) Mₙ measured by GPC; and D) Mₙ (GPC)/Mₙ (NMR) for bulk and solution polymerization reactions.

FIG. 1.3. GPC elution profile of A) block copolymers prepared by bulk polymerization at different reaction times, i.e., B₁₅, B_{16.5}, B₁₇; B) block copolymers prepared by solution polymerization at different reaction times, i.e., S₁₇, S₂₁, S₂₃; C) Molecular weight distribution of block copolymers prepared by bulk (B₁₅, B_{16.5}, B₁₇) and solution polymerization (S₁₇, S₂₁, S₂₃).

FIG. 1.4. A) An overlay of viscometer elution profiles. B) Double log plot of [η] vs M_{w} from GPC data.

FIG. 1.5. Storage modulus(G′), Loss modulus(G″) and complex viscosity (η*) of hydrogels under study at 15% w/w concentration as a function of temperature (heating rate of 1° C./min).

FIG. 1.6. A) The effect of polymerization time and method on the size of self-assembled structures from block copolymers under study at 25° C. Results are presented as Mean±SD (n=3). An asterisk denotes significant difference at P<0.05. B) Change in the size of self-assembled structures from block copolymers as a function of temperature at 1 mg/mL polymer concentration as measured by DLS.

FIG. 2.1. Correlation between reduction reaction time and percentage of debenzylation as measured by ¹H NMR spectroscopy (A & C) and Mₙ or M_{w} measured by GPC (B & D); for A and B) PBCL-PEG-PBCLPC copolymers in the “B” series (bulk polymerization); and C and D) PBCL-PEG-PBCLPC copolymers in the “S” series (solution polymerization).

FIG. 2.2. GPC elution profile detected by RI detector for A: “B” copolymers and C: “S” copolymers. Molecular weight distribution of B: “B” copolymers and D: “S” copolymers

FIG. 2.3. GPC elution profile measured by viscometer detector for A: “B” block copolymers and B: “S” copolymers.

FIG. 2.4. Evolution of moduli and viscosity in a temperature ramp experiment 10-50° C. with ramp rate of 1° C./min for “B” copolymers aqueous with concentration A:10 wt % and B:15 wt % . The dash line show intersection of G′ and G″ (sol-to-gel point). C: State diagram of Sol-gel transition for “B” copolymer aqueous solution at concentration 10, 15, 20 mg/ml.

FIG. 2.5. Viscoelastic behaviour of “S” copolymers aqueous solutions as a function of temperature at a heating rate 1° C./min (10-50° C.) for A. 10 wt % and B. 15 wt % polymer concentration. C: State diagram of Sol-gel transition for “S” copolymer aqueous solution at concentration 10, 15, 20 mg/mL.

FIG. 2.6. The effect of debenzylation time on the size of self-assembled structures from block copolymers synthesized by A: Bulk, B: Solution polymerization at 25° C. Results are presented as Mean±SD (n=3). Asterisks denote significant difference at P<0.05.

FIG. 3.1. The effect of polymerization reaction times on the A) Mₙ measured by ¹H NMR B) Mₙ measured by GPC (dashed line in figures show linear trendline).

FIG. 3.2. A: GPC elution profile of block copolymers at different reaction times. B: Molecular weight distribution of copolymers under study.

FIG. 3.3. A: GPC elution profile and B: Molecular weight distribution of copolymers after addition of PEG 200 or PEG 400 as cross-linker at different PEG:BCL molar ratios. The description of each polymer sample is detailed in Table 3.3.

FIG. 3.4. Storage modulus (G′), Loss modulus (G″) and complex viscosity (η*) of copolymers aqueous solutions as a function of temperature, concentration 15 wt % and heating rate 1° C./min (10-50° C.).

FIG. 3.5. A: The effect of PEG molecular weight and ratio (added to PBCL-PEG-PBCL as cross-linker) on the size of self-assembled structures from block copolymers under study at 25° C. Results are presented as Mean±SD (n=3). Asterisks denote significant difference at P<0.05. B: Change in the size of self-assembled structures from block copolymers under study as a function of temperature at 1 mg/mL polymer concentration as measured by DLS. C: Size distribution of self-assembled structures from block copolymers P1-P7 at 25° C.

### DETAILED DESCRIPTION

Biodegradable thermo-responsive polymers with sol-to-gel transition temperatures above room but below physiological temperatures are of great interest in the field of drug delivery, tissue engineering, adhesives, and other medical applications. The results of our study show, a distinct high-molecular weight population is produced during ring opening polymerization of BCL with dihydroxy PEG. Interestingly, the existence of this population at around 40% molar concertation (or greater) in the PBCL-PEG-PBCL polymer, was shown to be necessary for the formation of thermo-reversible and viscoelastic hydrogels from these polymers.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The term “about” can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the term “about” is intended to include values, e.g., weight percentages, proximate to the recited range that are equivalent in terms of the functionality of the individual ingredient, composition, or embodiment. The term about can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

The term “substantially” is typically well understood by those of skill in the art and can refer to an exact ratio or configuration, or a ratio or configuration that is in the proximity of an exact value such that the properties of any variation are inconsequentially different than those ratios and configurations having the exact value. The term “substantially” may include variation as defined for the terms “about” and “approximately”, as defined herein above.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

The term “alkyl” refers to a branched or unbranched hydrocarbon having, for example, from 1-20 carbon atoms, and often 1-12, 1-10, 1-8, 1-6, or 1-4 carbon atoms; or for example, a range between 1-20 carbon atoms, such as 2-6, 3-6, 2-8, or 3-8 carbon atoms. As used herein, the term “alkyl” also encompasses a “cycloalkyl”, defined below. Examples include, but are not limited to, methyl, ethyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like.

The term “heteroatom” refers to any atom in the periodic table that is not carbon or hydrogen. Typically, a heteroatom is O, S, N, P.

As used herein, the term “substituted” or “substituent” is intended to indicate that one or more (for example, in various embodiments, 1-10; in other embodiments, 1-6; in some embodiments 1, 2, 3, 4, or 5; in certain embodiments, 1, 2, or 3; and in other embodiments, 1 or 2) hydrogens on the group indicated in the expression using “substituted” (or “substituent”) is replaced with a selection from a suitable group known to those of skill in the art, provided that the indicated atom's normal valency is not exceeded, and that the substitution results in a stable compound. Substituents of the indicated groups can be those recited in a specific list of substituents described herein, or as one of skill in the art would recognize, can be one or more substituents selected from, but not limited to alkyl, alkenyl, alkynyl, alkoxy, halo, haloalkyl, hydroxy, hydroxyalkyl, aryl, heteroaryl, heterocycle, cycloalkyl, alkanoyl, alkoxycarbonyl, amino, alkylamino, dialkylamino, trifluoromethylthio, difluoromethyl, acylamino, nitro, trifluoromethyl, trifluoromethoxy, carboxy, carboxyalkyl, keto, thioxo, alkylthio, alkylsulfinyl, alkylsulfonyl, and cyano.

### Embodiments of the Technology

This disclosure provides a copolymer comprising monomer units of an alpha-carboxylate-epsilon-caprolactone (CL; a 2-oxooxepane-3-carboxylate) and ethylene glycol (EG). In some embodiments, the copolymer is a block copolymer comprising poly(CL) and poly(EG). In some embodiments, the copolymer is a triblock copolymer comprising poly(CL)-poly(EG)-poly(CL). In some embodiments, the copolymer further comprises a crosslinker that is linked to at least one of the alpha-carboxylate moieties.

In various embodiments, the copolymer is represented by Formula I:

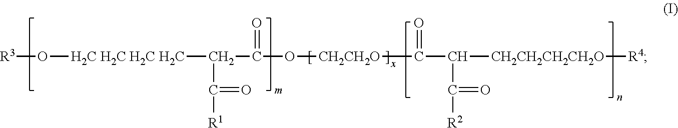

wherein

R¹ and R² are each independently a crosslinker, —OH, —O(C₁-C₆)alkyl, or —OCH₂Ph wherein Ph is optionally substituted;

R³ and R⁴ are terminal groups;

m and n are each independently an integer from 1-50; and
x is an integer from 5-150.

In some embodiments, m and n are each independently an integer from 2 to 30. In some embodiments, x is an integer from 5 to 50. In some embodiments, m is an integer from m1 to m2 wherein m1 is 1, 2, 3, 4, 5, 6, 7, 8, 9, or 10 and m2 is 12, 18, 24, or 30. In some embodiments, n is an integer from n1 to n2 wherein n1 is 1, 2, 3, 4, 5, 6, 7, 8, 9, or 10 and n2 is 12, 18, 24, or 30. In some embodiments, x is an integer from x1 to x2 wherein x1 is 1, 2, 3, 4, 5, 6, 7, 8, 9, 10, 11, 12, 13, 14, 15, 16, 17, 18, 19, or 20 and x2 is 9, 12, 18, 24, 30, 33, 46, 60, 80, 90, 100, 120, 136, or 150. In some embodiments the integer m is 1-12, 1-18, or 1-30. In some embodiments the integer n is 1-12, 1-18, or 1-30. In some embodiments the integer x is 33, 12-46, or 9-136.

In some embodiments, R¹ and R² are —OCH₂Ph. In some embodiments, R¹ and R² are —OH. In some embodiments, the crosslinker has at least two heteroatoms that are covalently bonded to the acyl moieties at R¹ and/or R² of Formula I.

In various embodiments, the crosslinker is: —(OCH₂CH₂)ₐO—; CH₃CH₂C(CH₂R⁵)₃ wherein R⁵ is —(OCH₂CH₂)_{b}O—; or CH₃CH₂C(CH₂OR⁶)₃ wherein R⁶ is —(C═O(CH₂)₅O)_{c}— wherein a, b, and c are each independently an integer from 1 to 100. In some embodiments, wherein a, b, and c are each independently an integer from 5 to 15.

In some embodiments, the crosslinker is —(OCH₂CH₂)ₐO—. In some embodiments, a is 2-21 or 8-10. In some embodiments, the crosslinker is CH₃CH₂C(CH₂R⁵)₃ wherein R⁵ is —(OCH₂CH₂)_{b}O—. In some embodiments, b is 2-8 or 4-6. In some embodiments, the crosslinker is CH₃CH₂C(CH₂OR⁶)₃ wherein R⁶ is —(C═O(CH₂)₅O)_{c}—. In some embodiments, c is 1-8 or 4-6.

In some embodiments, R¹ and R² are each independently the crosslinker and —OH. In some embodiments, R¹ and R² are each independently the crosslinker and —OCH₂Ph. In some embodiments, the number average molecular weight (Mₙ) or weight average molecular weight (M_{w}) is about 1,000 g/mol to about 80,000 g/mol.

Also, this disclosure provides a viscoelastic or thermo-reversible hydrogel comprising a copolymer according to claim 1. In some embodiments, the viscoelastic or thermo-reversible hydrogel comprises about 10 wt. % to about 50 wt. % of the copolymer. Additionally, this disclosure provides a method for forming the copolymer described herein comprising contacting benzyl 2-oxooxepane-3-carboxylate and polyethylene glycol for a sufficient period of time at above 25° C. to form a copolymer under ring-opening polymerization reaction conditions.

In some embodiments, the method further comprising at least partially debenzylating the copolymer and crosslinking the at least partially debenzylated copolymer with a crosslinker that comprises at least two primary alcohols. In some embodiments, the copolymer is formed by bulk polymerization or solution polymerization. In some embodiments, the monomers contacted are neat or in a solvent such as, but not limited to biphenyl, toluene, or xylene. In some embodiments, the method comprises an initiator, such as an alcohol or an alkoxide.

### Other Aspects of the Technology

In various embodiments, the thermo-reversible hydrogel, or viscoelastic gel described herein wherein the average molecular weight of a copolymer therein is at least about 38%, at least about 39%, at least about 40%, at least about 41%, molar concentration, or at least about 42%, molar concentration, of the block copolymer.

In various embodiments, the thermo-reversible hydrogel or viscoelastic gel described herein wherein a copolymer therein comprises one or more crosslinking agents that chemically crosslink PEG-PBCL, PBCL-PEG-PBCL, or PEG-PBCL-PEG block copolymers, or any combination thereof.

In various embodiments, the thermo-reversible hydrogel, or viscoelastic gel described herein wherein the crosslinking agent is a multinuclephilic crosslinker.

In various embodiments, the thermo-reversible hydrogel, or viscoelastic gel described herein wherein the crosslinking agent comprises one or more of a dihydroxyl or polyhydroxyl cross-linker, a diamine, a multifunctional amine, a di- or multi-functional lactone, or a polyol. In various embodiments, useful crosslinking agents for obtaining a polymer population with a high average molecular weight (or a chemically cross-linked population) that is at least about 40% molar concentration of the block copolymer sample include multinuclephilic crosslinkers that can be used to chemically cross-link PEG-PBCL or PBCL-PEG-PBCL or PEG-PBCL-PEG block copolymers. Non-limiting examples of multifunctional cross linkers include dihydroxyl or polyhydroxyl cross-linkers (such as dihydroxyl-PEG with MWts of about 200 Da to about 2000 Da, polycaprolactone triol, trimethylolpropane), phenols, diamines, multifunctional amines, and di- or multi-functional lactones (such as dibenzylcarboxylate-ε-caprolactone). Suitable cross-linkers include, but are not limited to, amines such as hexamethylenediamine, polyethylene glycol) diamine, Dytek® EP diamine, PEI, tris(2-aminoethyl)amine, Tris, Diethylenetriamine, and bis(hexamethylene)triamine, and polyols such as 1,5-anhydro-D-sorbitol, glycerol, ethylene glycol, and 1,5-pentanediol.

In various embodiments, the PCBCL-b-PEG-b-PCBCL copolymer can be exchanged for a copolymer described in Acta Biomaterilia 7 (2011) 3708-3718 (incorporated herein by reference). Examples of diblock copolymers that can be used to prepare a suitable hydrogel formulation include the copolymers described by Mahmud et al., Biomacromolecules 2009, 10, 30 471-478, which copolymers and related methods are incorporated herein by reference. Suitable molecular weights for blocks of the copolymer include, for example, about 300 Daltons to about 5,000 Daltons for PEG blocks and about 500 Daltons to about 5,000 Daltons for the caprolactone blocks (e.g., PCBCL, PBCL and the like). Other polymers, methods, techniques, and embodiments that can be used with the polymers and methods described herein are described in U.S. Provisional Application No. 62/836,757, which is incorporated herein by reference.

In various embodiments, the chemically cross-linked block copolymer contains a diblock or triblock of PEO and PBCL or PEO and PCBCL backbone or any polycaprolactone backbone containing an appropriate pendent leaving group.

### Pharmaceutical Formulations

Useful solid carriers include finely divided solids such as talc, clay, microcrystalline cellulose, silica, alumina, and the like. Useful liquid carriers include water, dimethyl sulfoxide (DMSO), alcohols, glycols, or water-alcohol/glycol blends, in which a compound can be dissolved or dispersed at effective levels, optionally with the aid of non-toxic surfactants. Adjuvants such as fragrances and additional antimicrobial agents can be added to optimize the properties for a given use. The resultant liquid compositions can be applied from absorbent pads, used to impregnate bandages and other dressings, or sprayed onto the affected area using a pump-type or aerosol sprayer.

Thickeners such as synthetic polymers, fatty acids, fatty acid salts and esters, fatty alcohols, modified celluloses, or modified mineral materials can also be employed with liquid carriers to form spreadable pastes, gels, ointments, soaps, and the like, for application directly to the skin of the user.

Examples of dermatological compositions for delivering active agents to the skin are known to the art; for example, see U.S. Pat. Nos. 4,992,478 (Geria), 4,820,508 (Wortzman), 4,608,392 (Jacquet et al.), and 4,559,157 (Smith et al.). Such dermatological compositions can be used in combinations with the compounds described herein where an ingredient of such compositions can optionally be replaced by a compound described herein, or a compound described herein can be added to the composition. In some embodiments, the dermatological composition may contain additional small molecule or protein-based therapeutics and be used for the treatment of dermatological disorders, transdermal delivery, or subcutaneous injection.

Useful dosages of the compositions described herein can be determined by comparing their in vitro activity, and in vivo activity in animal models. Methods for the extrapolation of effective dosages in mice, and other animals, to humans are known to the art; for example, see U.S. Pat. No. 4,938,949 (Borch et al.). The amount of a compound, or an active salt or derivative thereof, required for use in treatment will vary not only with the particular compound or salt selected but also with the route of administration, the nature of the condition being treated, and the age and condition of the patient, and will be ultimately at the discretion of an attendant physician or clinician.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

Example 1. The role of molecular weight disparity in triblock copolymers based on poly(α-benzyl carboxylate-ε-caprolactone) and poly(ethylene glycol) on the formation of thermo-reversible hydrogels.

1. Biodegradable thermo-responsive polymers with sol-to-gel transition temperatures above room but below physiological temperatures are of great interest in the field of drug delivery and tissue engineering. The results of our study show, a distinct high-molecular weight population is produced during ring opening polymerization of BCL with dihydroxy PEG. Interestingly, the existence of this population at around 40% molar concertation (or greater) in the PBCL-PEG-PBCL polymer, was shown to be necessary for the formation of thermo-reversible and viscoelastic hydrogels from these polymers.

### 2. Materials and Methods

2.1. Materials. α-Benzyl carboxylate-ε-caprolactone (BCL) was synthesized by Alberta Research Chemicals Inc (ARCI), Edmonton, Canada, based on a previous report by our group. Biphenyl (≥99%) and dihydroxy poly(ethylene glycol) (PEG) (Mw=1450) were purchased from Sigma-Aldrich (St. Louis, Mo.). Solvents such as tetrahydrofuran, dichloromethane and hexane were chemical reagent grade and purchased from Sigma-Aldrich (St. Louis, Mo.).

2.2. Synthesis of triblock copolymers. Synthesis of triblock copolymers was performed by ring opening polymerization of BCL by dihydroxy poly(ethylene glycol) (PEG) as initiator using bulk and solution polymerization. Synthesis of PBCL-PEG-PBCL triblock copolymer using bulk polymerization in the absence of catalyst has been described in our previous publication. In brief, 0.6 g of monomer (BCL) and 0.19 g PEG were dehydrated at 70° C. under vacuum for 3 h, then added to an ampule and sealed under vacuum. In solution polymerization, biphenyl (30% wt of monomer) was mixed with other ingredients, then the ampule was sealed under vacuum. The polymerization reaction was carried out at 160° C. for 16-23 h according to the preassigned conditions summarized in Table 1.1. The polymerization was quenched by cooling down the reaction container to ambient temperature. Prepared triblock copolymers were then purified by dissolving in tetrahydrofuran (THF), followed by precipitation using anhydrous ethyl ether and the supernatant decantation. The product was dried under vacuum for 24 h.

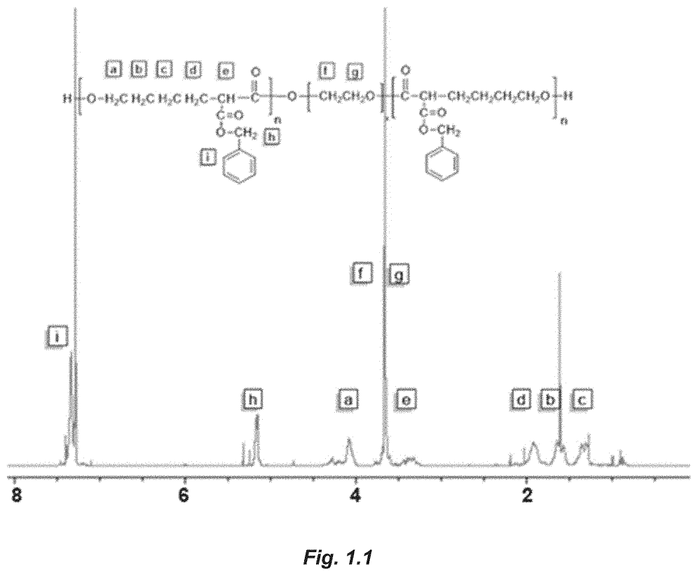

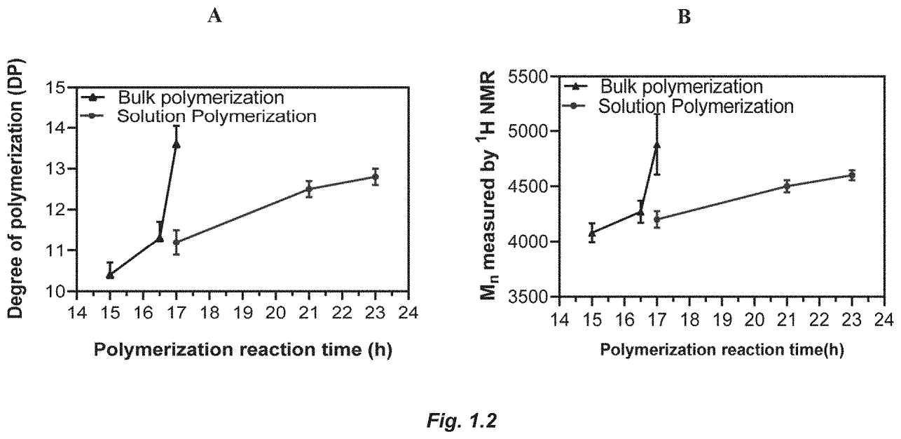

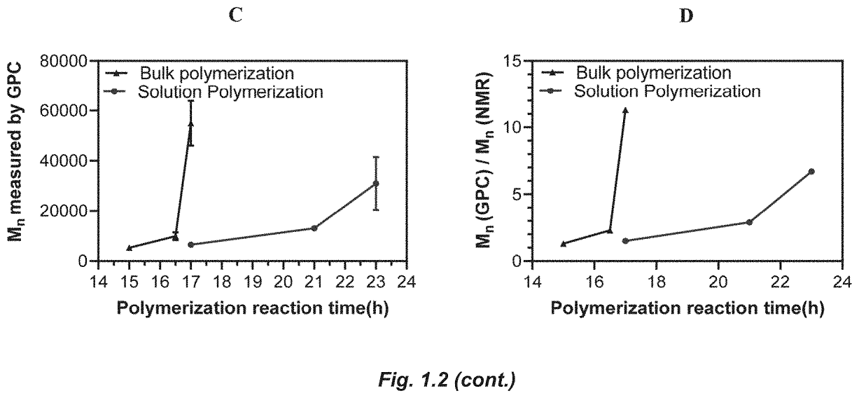

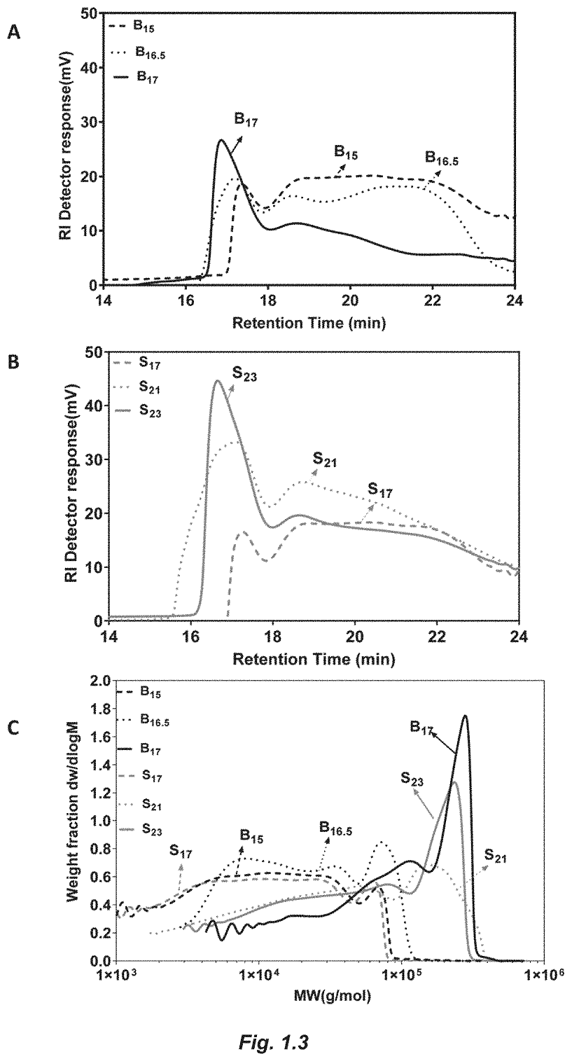

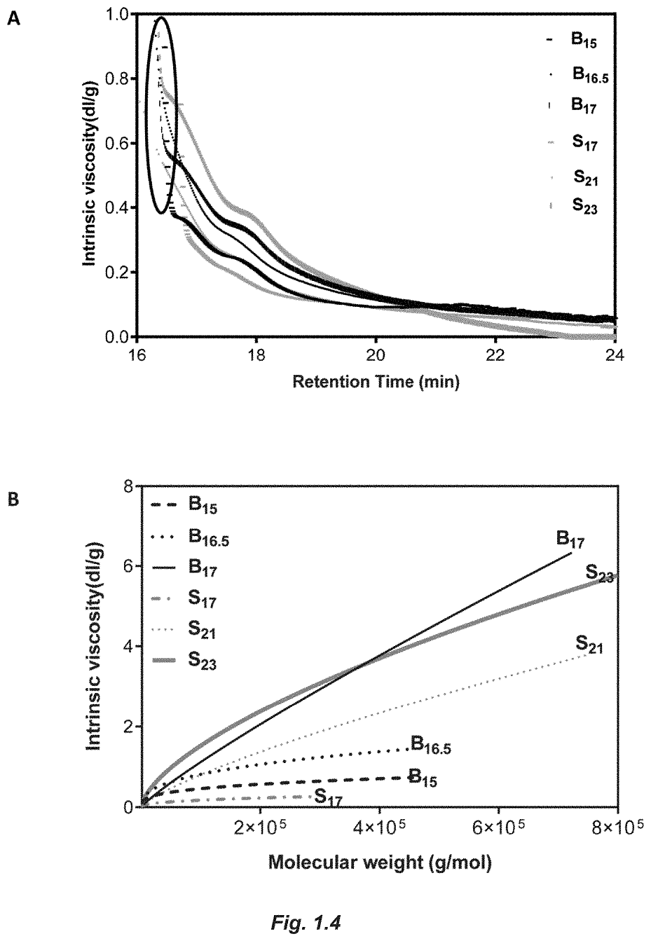

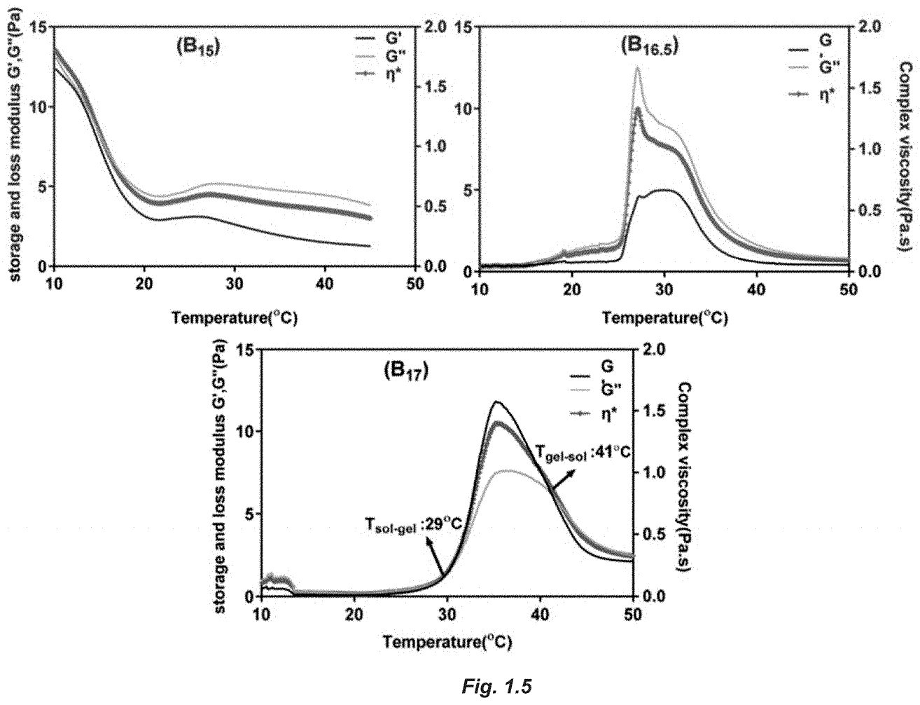

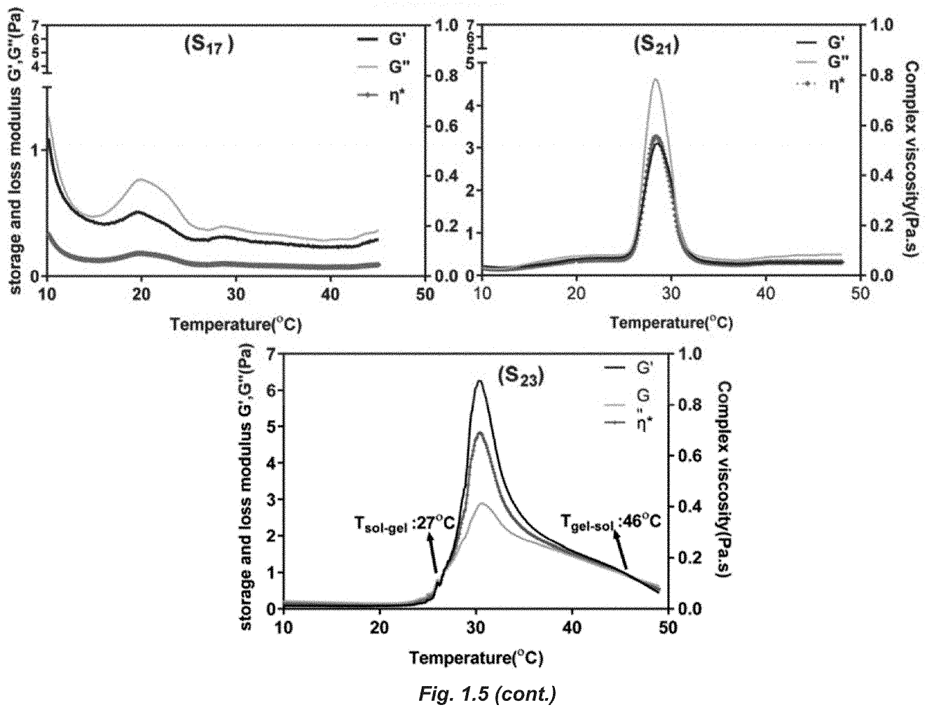

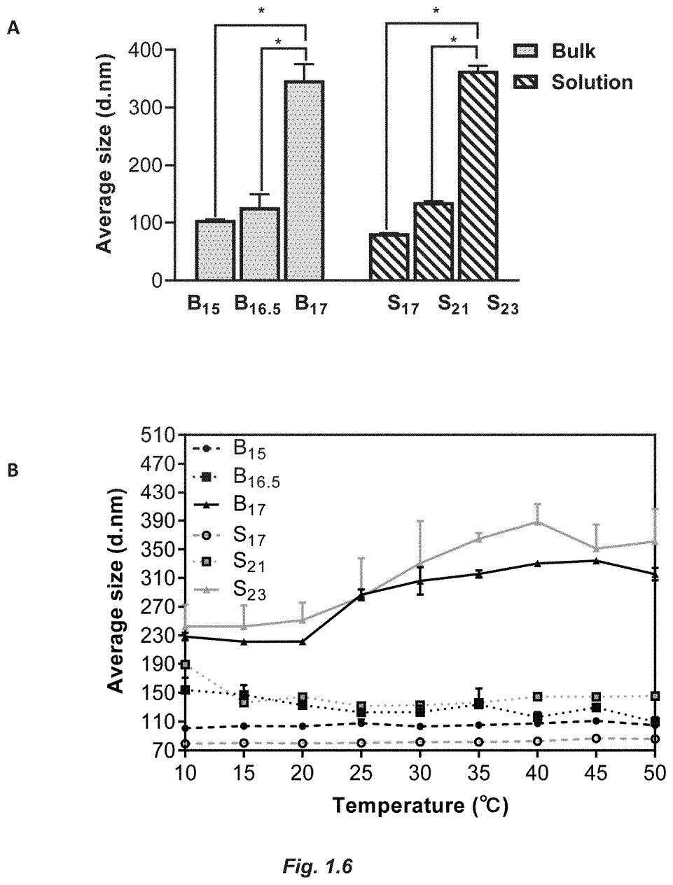

2.3. Characterization of synthesized triblock copolymers. Purified polymers were dissolved in CDCl₃ at a concentration of 5 mg/mL. ¹H NMR spectra of copolymers acquired by Bruker 600 MHz NMR were used to calculate the degree of polymerization (DP) of caprolactone blocks and then the number average molecular weight (Mn) of copolymers. The DP of caprolactone blocks was calculated by comparing the area under the peaks of methylene protons of the PEG block (CH₂CH₂O—, δ=3.65 ppm) to the methylene protons of the PBCL backbone (—OCH₂—, δ=4.1 ppm). The Mₙ of the PEG block was considered to be 1450 g/mol for these calculations (FIG. 1.1).

Retention time, average molecular weights (MW), molar-mass dispersity (Ð_{M}), intrinsic viscosity (η), and conformation of prepared block copolymers were estimated by gel permeation chromatography (GPC) (Agilent 1260 infinity with refractive index, light scatter and viscometer detectors) equipped with 2 columns (Styragel HR2 and Styragel HR 4E from Waters). The instrument was calibrated with a set of polystyrene standards with molecular weights ranging from 160 to 200,000 g/mol. Polymer samples (5-10 mg/mL) were dissolved in THF (HPLC grade) and filtered with a nylon syringe filter (pore size: 0.45 μm). Then 200 μL of samples were injected to GPC which was operated at a THF flow rate of 0.7 mL/min at 35° C.

2.4. Phase diagram by inverse flow method. Sol-gel transition of block copolymers under study in water was examined by the inverse flow method at a polymer concentration of 15% (w/w). Each vial contained 1 mL of copolymer solution and all samples were equilibrated at 4° C. overnight before measurement. Vials were immersed in a water bath at 30° C. and equilibrated for 15 min. If the vial content did not flow for at least 30 s in inverted vials, the sample was considered as gel.

2.5. Dynamic Rheological Measurements. The viscoelastic behaviour of the hydrogels at a concentration of 15% as a function of a rise in temperature between 10-50° C. was investigated by Discovery Hybrid Rheometer (TA instruments) in parallel plate geometry and auto gap set mechanism with a heating rate of 1° C./min, and angular frequency (w) 10 rad/s. Viscosity, storage and loss modulus of the copolymer solutions were measured as a function of temperature.

2.6. Characterization of thermo-responsive self-assembly of PBCL-PEG-PBCL. The block copolymer samples (10 mg) were dissolved in 1 mL of acetone, then 10 mL of distilled water was added to this solution dropwise. The mixture was stirred for 24 hours at room temperature to evaporate the acetone and reach a final polymer concentration of 1 mg/mL. The size of aggregates (intensity Z-average) as a function of a rise in temperature between 10-50° C. was measured using MALVERN Nano-ZS90 ZETA-SIZER with a laser beam at a wavelength of 633 nm. The scattered light was detected at an angle of 173°. The heating rate was 1° C./min.

2.7. Statistical analysis. The results are reported as average±standard deviation (SD) of three independent measurements on a single batch of polymer, unless mentioned otherwise. The statistical analysis was processed using GraphPad Prism software, version 8.3.1 (GraphPad Software Inc., La Jolla, Calif., USA). The significance of differences between results was assessed by one-way ANOVA analysis followed by Sidak's multiple comparison test where α=0.05 was set as the level of significance.

### 3. Results

### 3.1. Synthesis and Characterization of Triblock Copolymers.

Block copolymers of PBCL-PEG-PBCL were synthesized by ring-opening polymerization of BCL initiated by dihydroxy PEG without any catalyst using two methods of bulk and solution polymerization at different polymerization times (15-17.5 hours for bulk and 17-25 h for solution polymerization) as summarized in Table 1.1. The reaction times were chosen based on our pilot studies that have shown relatively similar polymer characteristics, i.e., similar DP for the PBCL segment (based on ¹H NMR data), for polymers produced by the two methods of polymerization at the corresponding reaction times. The scheme for the synthesis of PBCL-PEG-PBCL triblock copolymers is shown in Scheme 1.1.

To optimize the solution polymerization of BCL with dihydroxy PEG using biphenyl as a solvent, different quantities of biphenyl were used in the polymerization reaction while other parameters such as the ratio of monomer to PEG and reaction temperature were kept constant.

Optimum yield and degree of polymerization were achieved at biphenyl concentration of 30 wt % of the monomer (data not shown). Therefore, 30 wt % biphenyl was selected to prepare triblock copolymers through solution polymerization in further studies.

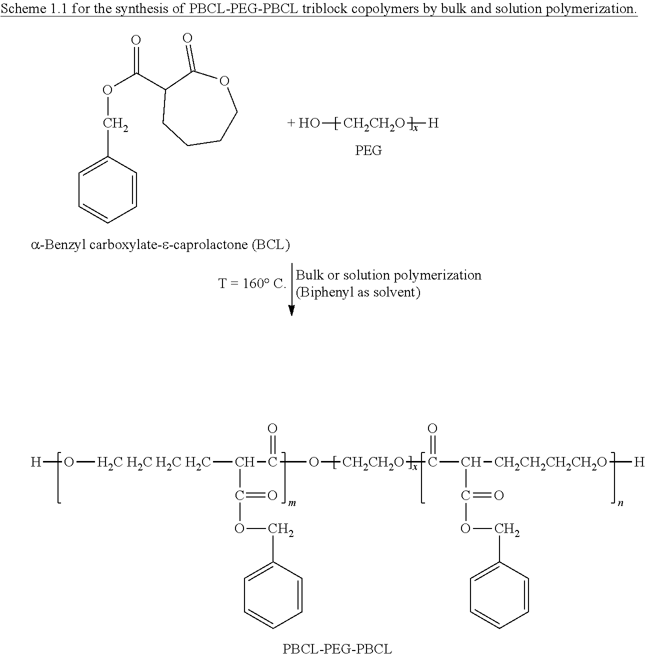

3.1.1. The effect of polymerization time on the average molecular weights and molecular weight distribution of block copolymers prepared by bulk versus solution polymerization. Characteristics of prepared polymers is summarized in Table 1.1. In general, the yield of reaction for solution polymerization was significantly higher than the bulk method in this study. The polymerization time also showed a positive correlation with the DP of prepared block copolymers, irrespective of the method of polymerization (Table 1.1).

TABLE 1.1
Characteristic of synthesized PBCL-PEG-PBCL triblock copolymers (theoretical MW
of copolymers was 6030 g/mol) (n = 3)

| | | | | | | | Appearance |
|---|---|---|---|---|---|---|---|
| Sample¹ | Polymerization Time (h) | DP² | Mₙ³ (Da) | Mₙ⁴ (Da) | $\frac{Mn ( GPC )}{Mn ( NMR )}$ | Yield (%) | in water at 30° C. |
| B₁₅ | 15 | 10.4 ± 0.30 ^{a} | 4080 ± 85 | 5300 ± 85 | 1.3 | 79 ± 6 | sol |
| B_{16.5} | 16.5 | 11.3 ± 0.40 ^{a} | 4270 ± 100 | 9900 ± 1500 | 2.3 | 78 ± 2 | sol |
| B₁₇ | 17 | 13.6 ± 0.45 ^{b} | 4880 ± 275 | 55000 ± 9000 | 11.3 | 74 ± 10 | gel |
| B_{17.5} | 17.5 | N/A | N/A | N/A | N/A | N/A | insoluble |
| S₁₇ | 17 | 11.2 ± 0.30 ^{a} | 4200 ± 75 | 6500 ± 570 | 1.5 | 90 ± 5 | sol |
| S₂₁ | 21 | 12.5 ± 0.20 ^{c} | 4500 ± 56 | 13000 ± 530 | 2.9 | 93 ± 3 | sol |
| S₂₃ | 23 | 12.8 ± 0.20 ^{bc} | 4600 ± 45 | 31000 ± 10600 | 6.7 | 89 ± 6 | gel |
| S₂₅ | 25 | N/A | N/A | N/A | N/A | N/A | insoluble |

¹B stands for Bulk polymerization and S stands for solution polymerization. The number in the subscript shows the reaction time in hours.
²Degree of polymerization (DP) of PBCL block measured by ¹H NMR.
³Number average molecular weight of block copolymers measured by ¹H NMR.
⁴Number average molecular weight of block copolymers measured by GPC.
Same superscript letters indicate no statistical significance while different letters mean statistical difference at P<0.05.

Using bulk polymerization, increasing the polymerization time from 15 to 17 hours led to a drastic increase in the DP of PBCL block from 10.4 to 13.6 (approximately 3 units) on average. However, in solution polymerization, the change was more gradual, i.e., a 6 h increase in reaction time (from 17 to 23 h) was needed for a 2-unit increase in the average DP of PBCL block to occur (FIG. 1.2A). A similar trend was observed for Mₙ based on ¹H NMR and GPC (FIG. 1.2B & FIG. 1.2C), indicating a more gradual increase in polymer chain growth enabling better control over polymerization degree in the solution versus bulk polymerization of BCL with PEG. The Mₙ (GPC)/Mₙ (NMR) ratios were always above 1, irrespective of the polymerization method, and elevated with an increase in reaction time. Moreover, the time dependent increase in Mₙ (GPC)/Mₙ (NMR) ratios was more gradual for polymers prepared by solution polymerization. For polymers prepared by bulk polymerization at 15, 16.5 and 17 h reaction time, the Mₙ measured by GPC were 1.3, 2.3 and 11.3-fold higher than those from NMR, respectively (Table 1.1, FIG. 1.2D). For polymers prepared by solution polymerization at 17, 21 and 23 h polymerization time, Mₙs measured by GPC were 1.5, 2.9 and 6.7-fold higher than Mₙs measured by NMR.

The GPC elution profiles of block copolymers that could form soluble samples in THF are shown in FIG. 1.3A and FIG. 1.3B. The extracted data from GPC is summarized in Table 1.2. Irrespective of the method of polymerization, increasing the reaction time, led to a decrease in the peak maximum retention time of block copolymers, implying an elevation in the hydrodynamic volume as a result of an increase in the molecular weight of the block copolymers. As shown in FIG. 1.3C and Table 1.2, in particular, B₁₇, S₂₁ and S₂₃ samples showed a distinct population of polymers with unexpectedly larger molecular weights. The calculated weight average molecular weight (M_{w}) for these samples were 188000, 73600 and 147900 g/mole, respectively. This was 31, 12.2 and 24.5-fold higher than the theoretical average molecular weight for these polymers, respectively.

TABLE 1.2
Characteristic of triblock copolymers under study from GPC (n = 3).

| | Peak Max | | | Intrinsic | | |
|---|---|---|---|---|---|---|
| | Retention Time | M_{w} ± SD ^{a} | | viscosity ± SD | K | |
| Sample | in GPC (min) | (g/mol) | Ð_{M} ± SD ^{b} | (dl/g) | (dL/g) ^{c} | α ^{c} |
| B₁₅ | 20.4 | 16700 ± 1100 | 3.1 ± 0.40 | 0.15 ± 0.01 | 0.0130 | 0.31 |
| B_{16.5} | 16.8 | 30500 ± 1370 | 3.1 ± 0.50 | 0.46 ± 0.04 | 0.0110 | 0.38 |
| B₁₇ | 16.5 | 188000 ± 9000 | 3.4 ± 0.24 | 0.48 ± 0.10 | 0.0005 | 0.87 |
| S₁₇ | 20.3 | 24600 ± 4600 | 3.7 ± 0.79 | 0.07 ± 0.01 | 0.0190 | 0.39 |
| S₂₁ | 16.8 | 73600 ± 3500 | 5.7 ± 0.16 | 0.41 ± 0.08 | 0.0002 | 0.76 |
| S₂₃ | 16.7 | 147900 ± 54500 | 4.8 ± 0.18 | 0.47 ± 0.06 | 0.0002 | 0.87 |

^{a} Weight average molecular weight.
^{b} Molar mass dispersity (M_{w}/Mₙ) measured by GPC.
^{c} Mark-Houwink parameters.

3.1.2. The effect of polymerization time and method on the intrinsic viscosity of block copolymer populations. FIG. 1.4A and FIG. 1.4B show the intrinsic viscosity plots of polymer populations for samples under study as a function of retention time and molecular weight analyzed by GPC, respectively. The data shows the existence of a polymer population with higher than expected intrinsic viscosity in polymers as defined by the marked region in FIG. 1.4A. Moreover, when analyzing the changes in the intrinsic viscosity versus molecular weight for polymer populations (FIG. 1.4B), it is evident that the B₁₇, S₂₃ and S₂₁ polymers behave differently as these samples showed a particularly steeper increase in their intrinsic viscosity vs molecular weight compared to B_{16.5}, B₁₅ and S₁₇ (FIG. 1.4B).

The average intrinsic viscosity and Mark Houwink constants (α and K) for each sample, are also illustrated in Table 1.2. The data shows a positive but non-linear correlation between polymerization time and α, irrespective of the polymerization method. The α value is similarly higher for the B₁₇, S₂₃ and S₂₁ polymers compared to B_{16.5}, B₁₅ and S₁₇.

### 3.2. Characterization of the Aqueous Solutions of Prepared Block Copolymers.

3.2.1. Thermo-gelation of copolymer aqueous solutions as measured by inverse flow method. Thermo-gelling behaviour of copolymers under study, was investigated through the inverse flow method. The B_{17.5} and S₂₅ copolymers were insoluble in water, thus, were not studied here. All other polymers become soluble in water at a concentration of 15 wt % at 4° C. Among the aqueous solutions of polymers under study (Table 1.1), only B₁₇ and S₂₃ showed gel formation at a concentration of 15 wt % at 30° C. Other samples remained soluble in water and did not form a visual gel at this concentration and temperature.

3.2.2. Temperature dependent viscoelastic gelation of block copolymer aqueous solutions. The changes of storage modulus (G′), loss modulus (G″) and complex viscosity (η*) as a function of temperature for aqueous solutions of block copolymers at 15 wt % is shown in FIG. 1.5. The B₁₅ sample showed typical behaviour of viscoelastic liquids, where both G′ and G″ modulus decreased as a function of a rise in temperature, while G″ dominated G′. Also, the η* of these samples decreased as a function of temperature. For B_{16.5} sample, the G′, G″ and η* showed a peak between 25-40° C. but G″ was higher than G′ indicating more viscose than elastic behaviour. The B17 sample, on the other hand, showed a distinct thermo-gelling behaviour with sol-to-gel transitions around 27-28° C., as evidenced by a crossover of the G′ and G″ graphs. The rise in temperature above 27-28° C., also led to an increase in the viscosity of B₁₇ aqueous solutions. Further increase in temperature in this sample, led to a decrease in viscosity and a second cross over of the G′ and G″ graphs, implying a gel-to-sol transition at 41° C.

A similar trend was observed for polymers prepared by the solution polymerization at 17, 21 and 23 h polymerization time. The S₁₇ sample showed a similar behaviour to that of B₁₅, representative of liquids, where both G′ and G″ modulus decreased with increasing temperature below 20° C. For this sample, a small increase in loss and storage modulus as well as viscosity was recorded between 17-25° C., but G″ dominated G′ at all temperatures under study. The S₂₁ sample showed similar behaviour to that of B_{16.5}, where the values of G′, G″ and η* showed a peak between 25-30° C. Similar to B_{16.5}, the loss modulus still dominated the storage modulus in this temperature range, indicating the dominance of viscous behavior. The temperature range for the viscous transition was narrower for S₂₁ compared to B_{16.5}, however. Similar to B₁₇, the S₂₃ polymer showed a true viscoelastic sol-gel transition at 27° C., which was reflected by a crossover of G″ and G′. A gel-sol transition was recorded for this sample at 46° C.

3.2.3. Temperature dependent self-assembly of block copolymers in aqueous solution. FIG. 1.6A shows the average size of self-assembled structures from copolymers under study at ambient temperature (25° C.) and in water. For polymers made using bulk polymerization, the average diameter of B₁₅ and B_{16.5} aggregates in water were similar, but aggregations assembled from B₁₇ showed significantly larger size at room temperature. For polymers made by solution polymerization, the S₂₃ polymers produced relatively larger aggregates at room temperature which were comparable to the self-assembled structures from B₁₇ samples. The size of aggregates from S₁₇ polymers was, on the other hand similar to that of B₁₅.

The change in the Z average diameter of self-assembled structures from block copolymers under study at a concentration of 1 mg/mL as a function of temperature (10-50° C.) was assessed by DLS using Zeta Sizer Nano. As shown in FIG. 1.6B, there was no significant change in the size of self-assembled structures formed by B₁₅ and B_{16.5} as a function of a rise in temperature. The B₁₇ sample on the other hand showed a significant increase in the size of its aggregates around 20° C. (FIG. 1.6B).

For polymers prepared by solution polymerization no change in the size of aggregates as a function of a rise in temperature was observed for S₁₇ sample. The S₂₁ sample showed a decrease in size between 10-15° C. and plateaued after. On the other hand, S₂₃ showed thermo-responsive increase in the size of its self-assembled structures between 20-25° C., which was similar to that observed for the B₁₇ polymers.

### 4. Discussion

The development of stable, reproducible, bio-compatible and viscoelastic thermo-reversible hydrogels is of interest in the field of depot drug delivery and tissue engineering. In the present study, we characterized block copolymers of PBCL-PEG-PBCL synthesized by two methods of solution versus bulk polymerization (Scheme 1.1) in detail, in order to define structural characteristics of these block copolymer that can lead to the formation of viscoelastic thermo-reversible hydrogels in a controlled manner.

The results showed in both methods of polymerization, expanding the polymerization time, to increase the DP, Mₙ and viscosity of the products, as expected. The use of solution polymerization, on the other hand, improved the controllability and yield of the reaction when compared to the bulk polymerization (Table 1.1). This was evident from the slope of increase in average DP and Mₙ of polymers versus time, which was less steep for solution polymerization compared to bulk polymerization (FIG. 1.2). This was not surprising, since the solvent acts as a diluent facilitating the transfer of heat in the polymerization reaction by reducing the viscosity of the reaction mixture compared to bulk polymerization. The same explanation can also be used to describe the reason for the increase in the yield of polymerization.

Interestingly, the GPC data confirmed the formation of a distinct polymer population with higher-than-expected average molecular weights (FIG. 1.3) as well as intrinsic viscosity (FIG. 1.4) in all polymers under study. The proportion of this distinct population seemed to increase as a result of an increase in reaction time. Particularly, for B₁₇ and S₂₃ samples the proportion of this population became very noticeable and significant, around 40% molar concentration (FIG. 1.3 and FIG. 1.4).

The formation of long homopolymers of PBCL during polymerization reaction, cannot explain the distinctly high molecular weight population of block copolymer in the 10-55 KDa MWt range, as the added quantity of the monomer to achieve a theoretical MWt of ˜6 KDa is not enough to produce such large linear polymers (˜30-55 KDa). But the distinct and unexpectedly larger molecular weight population may be attributed to the formation of a nonlinear molecular architecture branched and/or partially cross-linked polymer populations in our products, which is increased in proportion as a function of an increase in the polymerization time. A higher-than-expected intrinsic viscosity for this polymer population is observed in all samples under study. The higher-than-expected average intrinsic viscosity in B₁₇, S₂₁ and S₂₃ polymers, in particular, which coincides with a significant proportion of large molecular weight population in these samples may indicate the formation of partially cross-linked polymers with a distinctly larger proportion in these samples (FIG. 1.4B), rather than branching to be a potential explanation for the production of very high MWt segment in these samples. In fact, above 17 h (in the bulk polymerization) and 23 h (in the solution polymerization), we observed the formation of solid and insoluble structures. This observation also confirms our explanation of the formation of partially cross-linked structures in PBCL-PEG-PBCL polymers, with particular growth in proportion in the B₁₇ and S₂₃ samples. Above these time points, it can be speculated that the growth of cross-linked copolymer population passed the threshold for polymer solubility in water or organic solvents and led to the formation of insoluble polymers.

Remarkably, our further studies showed polymer samples with a higher proportion of the higher-than-expected molecular weight populations (B₁₇ and S₂₃) are in fact the ones capable of forming thermo-gelling hydrogels with enhanced viscoelastic properties (FIG. 1.5). In constant angular frequency, the crossover of the loss (G″) and storage (G′) moduli occurs near gel point. Rheological behaviour of polymers under study showed, only B₁₇ and S₂₃ can produce thermo-reversible hydrogels with a crossover of G′ over G″. Based on GPC results, the same two samples are the ones showing the highest average Mₙ (GPC)/Mₙ (NMR) ratios deviating from their theoretical molecular weights (Table 1.1) as well as the highest αs (Table 1.2). The collection of the above evidence, all point to the defining role of a higher-than-expected molecular weight population in PBCL-PEG-PBCL polymers in the formation of viscoelastic thermo-reversible hydrogels.

Our results also indicated the more gradual pace in the formation of this high molecular weight polymer population by the solution polymerization. This is particularly indicated by a sharp change in the viscosity profiles of B_{16.5} versus B₁₇ samples (only 30 minutes difference in polymerization time) compared to a more gradual profile change for S₂₁ and S₂₃ samples (2 h difference in polymerization reaction) (FIG. 1.4B). In general, the solution polymerization seems to be a preferred choice for the preparation of polymers under study as it provides opportunity for better control of reaction outcome avoiding sharp changes in polymer characteristics leading to the sudden growth of high-molecular weight population within a short reaction time.

In line with the above explanations, we found polymers with thermo-responsive properties (B₁₇ and S₂₃) to self-assemble to aggregates of higher diameter compared to other polymers under study. The size of aggregates formed from block copolymers is determined by their molecular weight and/or aggregation number. Here, the B₁₇ and S₂₃ with significantly higher molecular weight compared to other polymers, self-assembled to particles with diameter of around 350 nm at ambient temperature. This might reflect larger hydrophobic structures due to branching or cross-linking of PBCL segment, but further studies are required to investigate the reason behind this observation.

In compliance with the result of rheological studies, only these two polymers (B₁₇ and S₂₃) showed thermo-responsive increase in size of self-assembled structure at temperatures which are consistent with their sol to gel transition temperatures. This may imply a temperature triggered self-association of polymers with branched or partially crosslinked PBCL as the mechanism inducing thermo-reversible gelation of PBCL-PEG-PBCL triblock copolymers in water.

To the best of our knowledge, this is the first report on the role of a higher-than-expected molecular weight polymer population on the formation of thermo-reversible viscoelastic hydrogels based on PEG and functionalized poly(ester)s synthesized by bulk vs solution polymerization methods. Although the evidence from the detailed characterization of polymers and hydrogels under study, strongly point to the formation of partially cross-linked or branched populations in PBCL-PEG-PBCL polymers, to be responsible for the formation of this higher-than expected molecular weight population, further studies are required to characterize the chemical structure of this population better. We propose a nucleophilic acyl substitution reaction between the hydroxyl group of PEG (particularly those at a shorter molecular weight in the PEG population) and benzyl carboxylate pendant groups on the polymer backbone (Scheme 1.2) to explain the mechanism for partial cross-linking or branching of the polymer. Although the potential for the existence of cross-linking impurities in the monomer or role of hydroxyl terminated PBCL containing polymers as potential branching reactants and/or cross-linkers cannot be ruled out and needs further investigations.

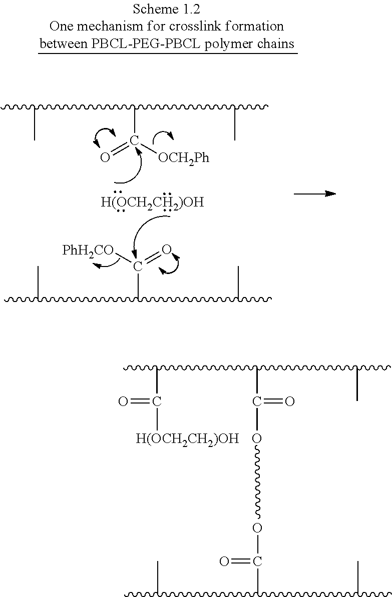

### 5. Conclusions

Our results showed the PBCL-PEG-PBCL can be synthesized through both bulk and solution ring opening polymerization, although the solution method of polymerization was proved to provide a better opportunity to control the chain growth during the process. We have provided evidence for the formation of a higher-than expected molecular weight population with distinctly high intrinsic viscosity in PBCL-PEG-PBCL structure in both polymerization methods, in their GPC profiles. Interestingly the thermo-reversible formation of viscoelastic gels in aqueous media was only observed in polymer samples with around 40 mol % of this population, i.e., B₁₇ and S₂₃.

In polymer samples with a lower level of high-molecular weight population, viscoelastic gel formation as a function of a rise in temperature was not observed. The data have indicated the defining role of this higher-than-expected molecular weight population (which was perhaps formed through partial cross-linking or branching of the PBCL part during polymerization reaction) in the formation of viscoelastic thermo-reversible hydrogels from PBCL-PEG-PBCL block copolymers.

Example 2. Partially cross-linked triblock copolymers based on carboxyl/benzyl carboxylate substituted PCL and PEG: Polymer characteristics leading to thermo-reversible transition to viscoelastic gels.

Characterization of the effect of carboxyl group substitution in partially cross-linked tri-block polymers (ABA) based on Polyethylene glycol (PEG) as the middle block, and a carbon functionalized poly(ε-caprolactone) (PCL) is described herein. For this purpose, partially cross-linked triblock copolymers of poly(α-benzyl carboxylate-ε-caprolactone)-PEG-poly(α-benzyl carboxylate-ε-caprolactone)(PBCL-PEG-PBCL) were synthesized through bulk or solution polymerization.

The existence of partial cross-linking in the produced block copolymers was confirmed by gel permeation chromatography (GPC). The α-benzyl carboxylate substitution on the PBCL blocks of the partially cross-linked PBCL-PEG-PBCL was then converted to carboxyl groups in a hydrogenation reaction changing the reaction time between 20-120 minutes. This led to the synthesis of partially cross-linked block copolymers with different degrees of carboxyl/benzyl carboxylate substitutions on the hydrophobic blocks. We then characterized the prepared polymers for their average molecular weights, polydispersity and intrinsic viscosity by GPC using three detectors of light scattering, refractive index and viscosity.

An aqueous solution of the prepared triblock copolymer was also assessed for their thermo-responsive gelation using inverse flow method and oscillatory shear rheology measurements. Our investigations showed a correlation between the thermo-reversible sol-gel transition of reduced PBCL-PEG-PBCLs in water with the degree of carboxyl group substitution on the polymer backbone.

### 1. Introduction

Thermo-hydrogels, defined as aqueous polymer solutions that become gel by increasing temperature, are of interest in different fields. For use in bio-related areas, thermo-gelling polymers with sol to gel transition temperatures around the physiological range (typically between 25 to 37° C.) are the subject of particular attention. This is owed to their potential application as smart hydrogels for the delivery of pharmaceuticals and/or stimulus responsive scaffolds for tissue engineering applications. Thermogelling polymers with a poly(ester) based structure can add the benefit of biodegradability to the above properties, providing new opportunities in the development of new and improved pharmaceutical excipients and/or biomaterials that support in vivo tissue/cell implantation or proliferation.

In this category, copolymers of poly(ethylene glycol) (PEG) and poly(caprolactone) (PCL) as FDA-approved, biodegradable and biocompatible biomaterials with thermogelling properties have been the focus of some studies. For instance, Bae et al found an aqueous solution of PCL-PEG-PCL to undergo sol-gel transition as a function of an increase in temperature. They found the transition temperature to be dependent on the hydrophilic/hydrophobic balance of the polymer, and the thermal history of the copolymer aqueous solution. They also proposed that the sol-to-gel transition occur by micellar aggregation, whereas the gel-to-sol transition to occur by increasing PCL molecular motion leading to micellar breakage.

Despite great potential, the lack of functional groups as well as the high crystallinity and hydrophobicity of PCL segment, has limited the use of conventional PEG/PCL hydrogels. Our research group has reported on the introduction of functional groups on caprolactone monomer, developing α-benzyl carboxylate-ε-caprolactone (BCL) and further polymerization of this functionalized monomer through bulk ring opening polymerization by methoxy poly(ethylene oxide), leading to the production of PEO-block-poly(α-benzyl carboxylate-ε-caprolactone) (PEO-b-PBCL) diblock copolymers in 2006. We have later reported on the preparation of triblock copolymers through ring opening polymerization of BCL by dihydroxy poly(ethylene glycol) (PEG) leading to the production of PBCL-b-PEG-b-PBCL (Pharm Res 2016; 33(2):358-366). The benzyl carboxylate groups on PEO-b-PBCL and PBCL-b-PEG-b-PBCL block copolymers prepared by bulk polymerization were also reduced to carboxyl groups at different degrees, leading to the conversion of PBCL blocks to poly(α-carboxyl-ε-caprolactone)-co-poly(a-benzyl carboxylate-ε-caprolactone) (PCBCL). In further studies, we investigated the effect of solution versus bulk polymerization on the characteristics of PBCL-PEG-PBCL block copolymers and gelling behaviour of produced polymers in an aqueous environment. In that study, we provided evidence for the presence of a partially cross-linked subpopulation in synthesized PBCL-PEG-PBCL structures. We also showed the defining role of this partially cross-linked subpopulation at around 40% molar concentration in the thermo-reversible transition of aqueous solutions of PBCL-PEG-PBCL to viscoelastic gels.

In the present example, we used the PBCL-PEG-PBCL copolymers having this subpopulation of high molecular weight polymers and reduced the PBCL segment using different hydrogenation reaction times (Scheme 2.1). The original partially cross-linked PBCL-PEG-PBCL (or PBCL-PEG-PBCLpc) copolymers used in the reduction reaction was prepared through either bulk or solution polymerization methods. The partially cross-linked (PC) copolymers based on PEG and carboxyl/benzyl carboxylate substituted PCL blocks (abbreviated as PCBCL-PEG-PCBCL_{PC}) were then characterized for their average molecular weights, molecular weight distribution, conformation, and intrinsic viscosity. The effect of the level of carboxyl substitution on the polymer backbones, on their transition to viscoelastic gels in water as a function of a rise in temperature, was investigated. Our results indicated that the thermo-gelling behaviour of PCBCL-PEG-PCBCL_{pc} and their viscoelastic properties depend on the percentage of carboxyl group substitution on the PCBCL segment.

### 2. Materials and Methods.

2.1. Materials. α-benzyl carboxylate-ε-caprolactone (BCL) was synthesized by Alberta Research Chemicals Inc (ARCI), Edmonton, Canada based on methods reported by our group. Biphenyl (≥99%), dihydroxyl-poly(ethylene glycol) (PEG) (Mw=1450) and palladium on activated charcoal were purchased from Sigma-Aldrich (St. Louis, Mo.). Other chemicals such as Dichloromethane, Tetrahydrofuran and hexane were chemical reagent grade and bought from Sigma-Aldrich.

2.2. Synthesis of triblock copolymers. The synthesis of copolymers was accomplished in two steps (Scheme 2.1). In the first step, ring opening polymerization of BCL as a monomer and dihydroxy polyethylene glycol (PEG) as initiator was carried out through bulk and solution polymerization. Briefly, 2.4 g of BCL and 0.76 g PEG were dried at 60° C. in a vacuum oven for 3 h. For solution polymerization, BCL, PEG and biphenyl (30% w/w monomer) were mixed in an ampule and sealed under a vacuum. In bulk polymerization, only BCL and PEG, at the same quantities, were mixed and vacuum sealed. Polymerization was conducted without any catalyst at 160° C. in 14 and 23 h for bulk and solution methods, respectively. The time of polymerization reaction was optimized to provide sufficient time for the appearance of the high molecular weight subpopulation in the produced polymers.

Prepared copolymers were then dissolved in dichloromethane and precipitated in hexane and supernatant was discarded after 24 hours. For more purification, tetrahydrofuran (THF) and anhydrous ethyl ether were used as solvent/non-solvent system and the above-mentioned purification procedure was repeated three times to wash off the excess monomer and other impurities, as much as possible. After purification, the product was dried under vacuum for 24 h.

This step led to the production of PBCL-b-PEG-b-PBCL_{PC} copolymers. In the second step reduction or debenzylation of PBCL-PEG-PBCL_{PC} copolymers was performed, which resulted in the preparation of PCBCL-b-PEG-b-PCBCL_{PC}. This was accomplished in the presence of hydrogen gas, palladium on activated charcoal as catalyst (10 wt. % of the polymer) and dry THF as solvent. The reaction time in this step was changed between 20 to 120 minutes to achieve different degrees of debenzylation on the PBCL section. The final product was centrifuged 2 times at 3000 rpm for 5 min to separate charcoal, then the supernatant was dried under vacuum for 24 h.

### 2.3. Characterization of Triblock Copolymers

Nuclear Magnetic Resonance (NMR). Prepared block copolymers were dissolved in CDCl₃ at a concentration of 5 mg/mL for ¹H NMR spectroscopy using 600 MHz Bruker NMR. ¹H NMR spectroscopy of copolymers (FIG. 1.1) was used to calculate the degree of polymerization (DP) and number average molecular weight (Mₙ) of PBCL-PEG-PBCL by comparing peak intensity of PEG (—CH₂CH₂O—, δ=3.65 ppm) to that of PCL backbone (—OCH₂—, δ=4.05 ppm) assuming a 1450 g/mol molecular weight for PEG. The percentage of reduction (i.e., debenzylation) in PCBCL-PEG-PCBCL was estimated using the following equation.

$$Reduction ( \% ) = \frac{\begin{matrix}( DP of PCBCL backbone ) - \\ ( benzyl substitution on PCBCL )\end{matrix}}{( DP of PCBCL backbone )}$$

The DP of the PCBCL backbone was calculated by comparing the area under the peak for (—CH₂O—, δ=4.1 ppm) to that of PEG (—CH₂CH₂O—, δ=3.65 ppm). The number of benzyl substitutions on PCBCL was then estimated by comparing the area under the peak for the methylene protons of the benzyl carboxylate group (Ph-CH₂—O—C═O, δ=5.15) compared to that for PEG (—CH₂CH₂O—, δ=3.65 ppm).

Gel permeation chromatography (GPC). Prepared copolymers were characterized for their average molecular weights (MW), molar-mass dispersity (Ð_{M}), intrinsic viscosity and conformation by GPC (Agilent 1260 infinity series (Agilent, USA) with Refractive index, light scatter and viscometer detectors) equipped with 2 columns (Styragel HR2 and styragel HR 4E from waters company, USA). The instrument was calibrated with a set of polystyrene standards covering a molecular weight range of 160-200,000 g/mol. Samples (5-10 mg/mL) were prepared in THF (HPLC grade) and filtered with a nylon syringe filter (pore size: 0.45 μm). Then 200 μL of samples were injected into GPC which was operated at a THF flow rate of 0.7 mL/min at 35° C.

Dynamic Rheological Measurements. The viscoelasticity of the copolymer solutions in water (concentration of 10 and 15 wt %) as a function of an increase in temperature was investigated by Discovery Hybrid Rheometer (TA instruments) in parallel plate geometry and auto gap set mechanism. The heating rate was 1° C./min (10-50° C.), with angular frequency ω as 10 rad/s.

Phase diagram or state diagram. The sol-gel transition was examined by the inverse flow method at 10-20% w/v of polymer concentration in water. Each vial contained 1 mL of copolymer solution and all samples were equilibrated at 4° C. overnight before measurements. Vials were immersed in a water bath and the temperature was raised from 10 to 50° C. at 2° C. intervals. The vials containing the above samples were equilibrated for 15 min at each temperature. If the liquid inside the vial did not flow for at least 30 seconds, the sample was regarded as a gel.

Characterization of thermo-responsive self-assembly of block copolymers. The effect of a rise in temperature between 10 to 50° C. on the self-assembly of prepared block copolymers was investigated using MALVERN Nano-ZS90 ZETA-SIZER (Malvern Instruments Ltd, Malvern, UK).

For sample preparation, 10 mg of the block copolymer was dissolved in 1 mL of acetone, then 10 mL of distilled water was added to this solution dropwise. The mixture was stirred for 24 hours at room temperature to evaporate the acetone. The micellar diameter was determined with zetasizer equipped laser at a wavelength of 633 nm using intensity function. The scattered light was detected at an angle of 173°. The Z-average of self-aggregated block copolymers was measured as a function of an increase in temperature.

### 3. Results and Discussion

Characterization of block copolymers. The PBCL-PEG-PBCL triblock copolymers were synthesized via ROP of BCL and PEG by two methods of bulk and solution polymerization (Scheme 2.1). The reaction time for the bulk and solution methods of polymerization was selected at 14 and 23 h, respectively, as at these reaction times, the formation of the high molecular weight subpopulation in the polymer samples was expected. The GPC analysis of PBCL-PEG-PBCL samples prepared by bulk and solution polymerization (denoted here as B₀ and S₀, respectively) provided evidence for the presence of this high molecular weight population. Specifically, 7.9- and 9.7-fold increase in the number average molecular weights (Mₙ) as measured by GPC compared to that calculated from ¹H NMR spectroscopy, was observed for B₀ and S₀ products, respectively (Table 2.1 and Table 2.2) pointing to the formation of cross-linked or branched structures in the copolymer population.

The purified PBCL-PEG-PBCLpc copolymers (B₀ and S₀) were then reduced using continuous hydrogenation in the presence of palladium on activated charcoal (Scheme 2.1). The degree of reduction was controlled by changing the reaction time between 0-120 min as summarized in Table 2.1 and Table 2.2. This led to the production of different PCBCL-PEG-PCBCL_{PC} copolymers denoted as the “B” series for polymers reduced from B₀ (or PBCL-PEG-PBCL_{PC} prepared by bulk ROP, Table 2.1) and “S” series for polymers reduced from S₀ (PBCL-PEG-PBCL_{PC} prepared by solution ROP, Table 2.2).

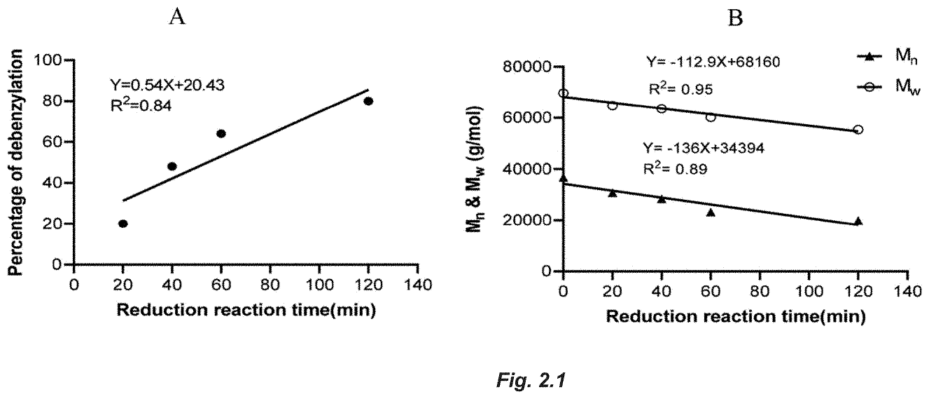

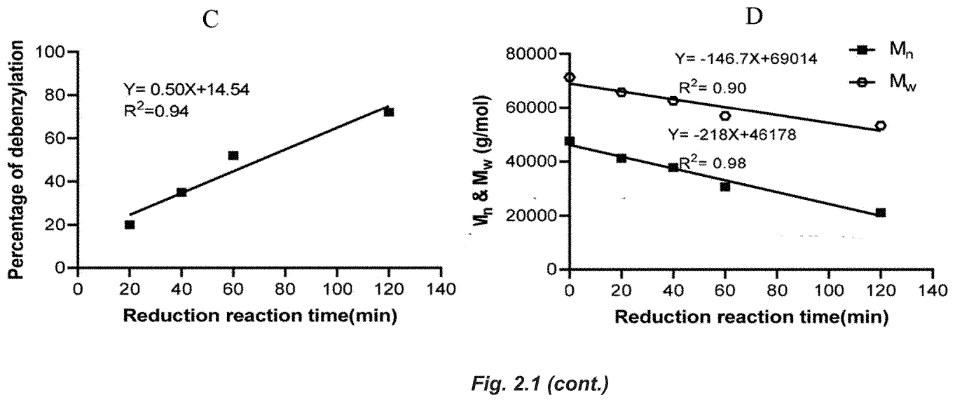

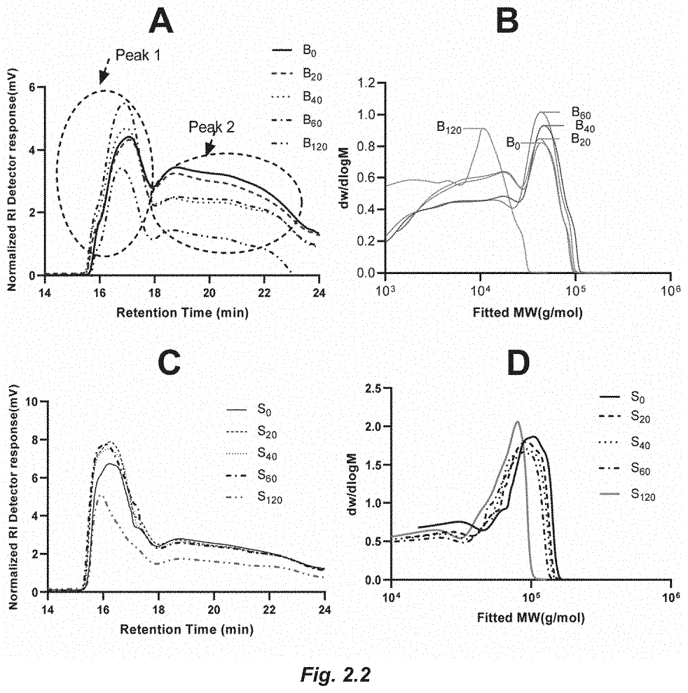

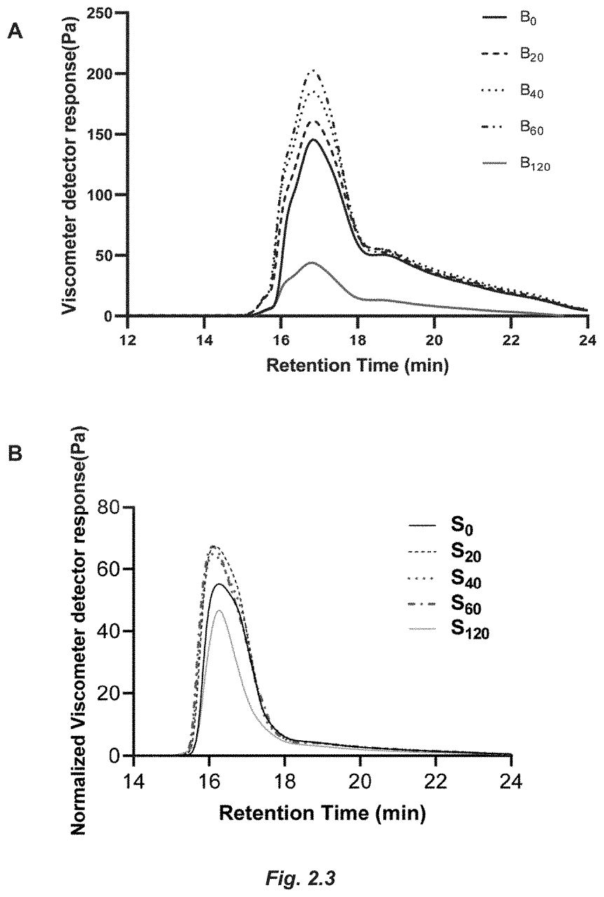

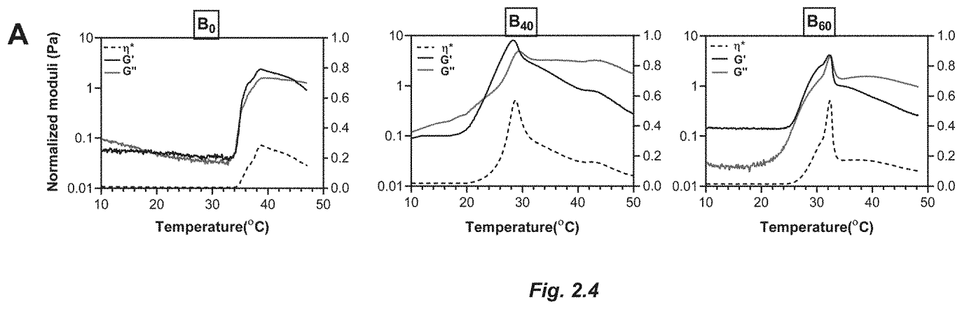

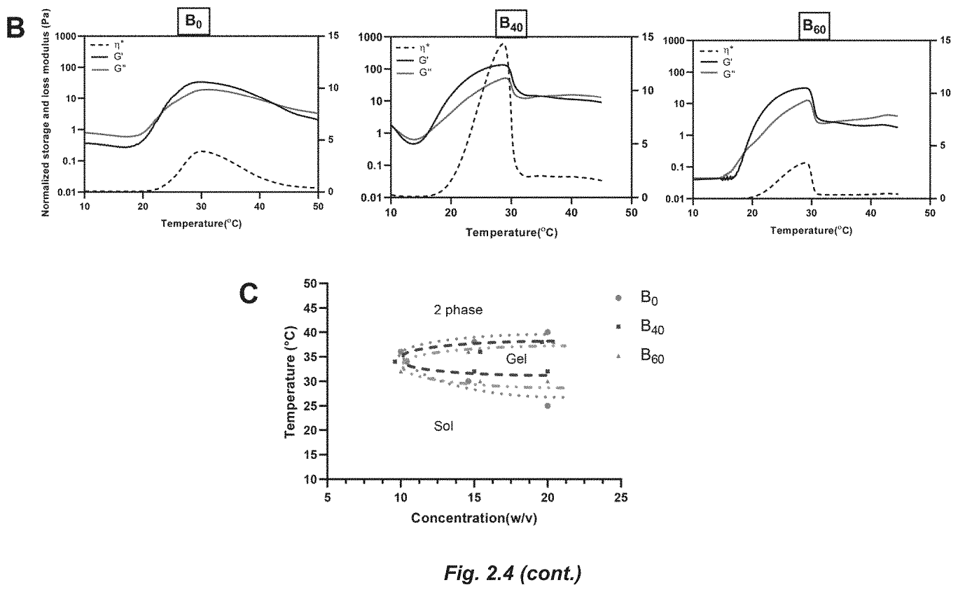

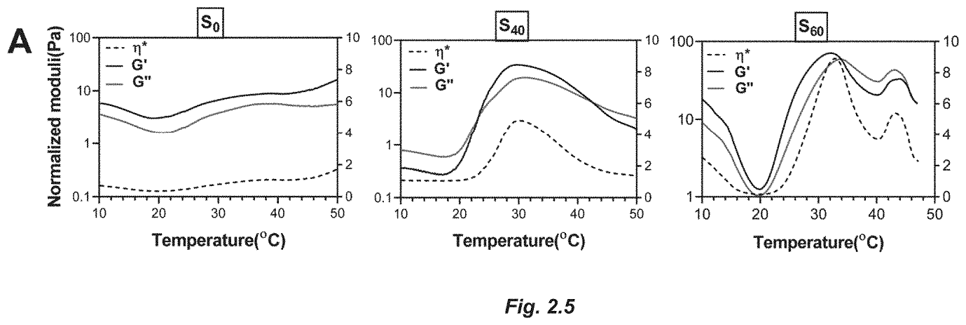

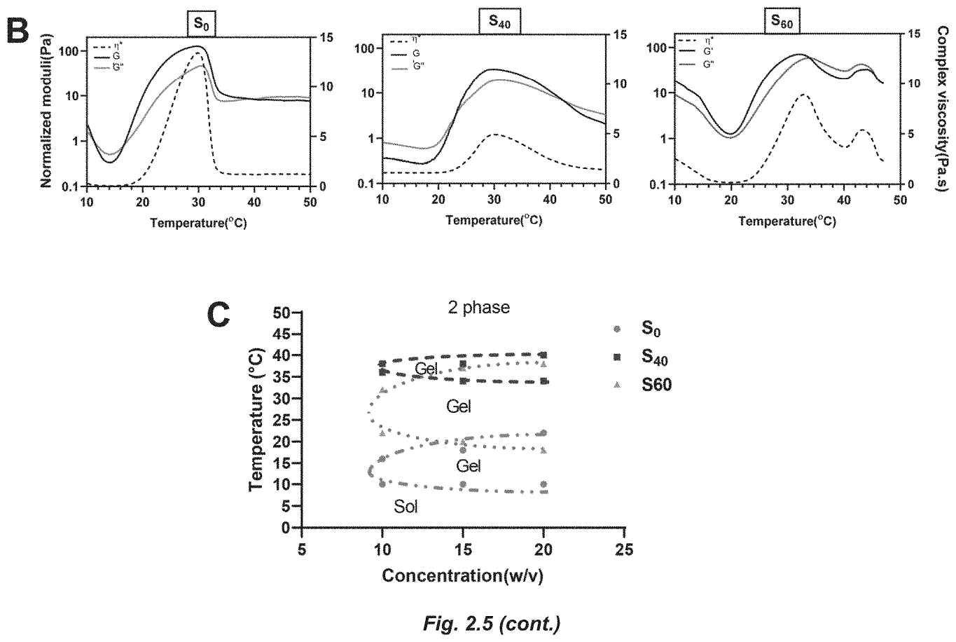

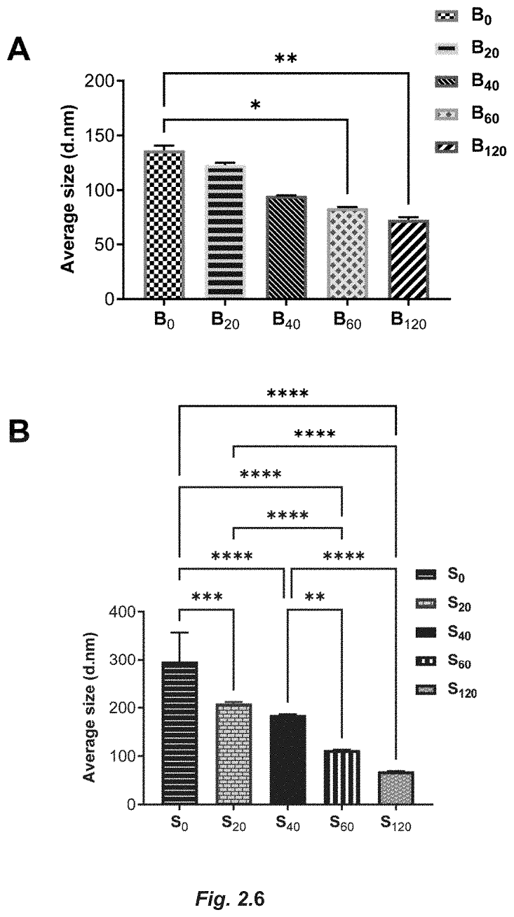

Upon reduction of B₀, with a rise in the reaction time, the molecular weight of the polymer (measured by ¹H NMR) was reduced. A positive relatively linear correlation (r² of 0.84) was observed between reduction time and degree of debenzylation for polymers in the “B” series (FIG. 2.1A). With increasing reduction time, Mₙ and M_{w} as measured by GPC, declined linearly (r²=0.89 and 0.95 for Mₙ and M_{w}, respectively) (FIG. 2.1C).

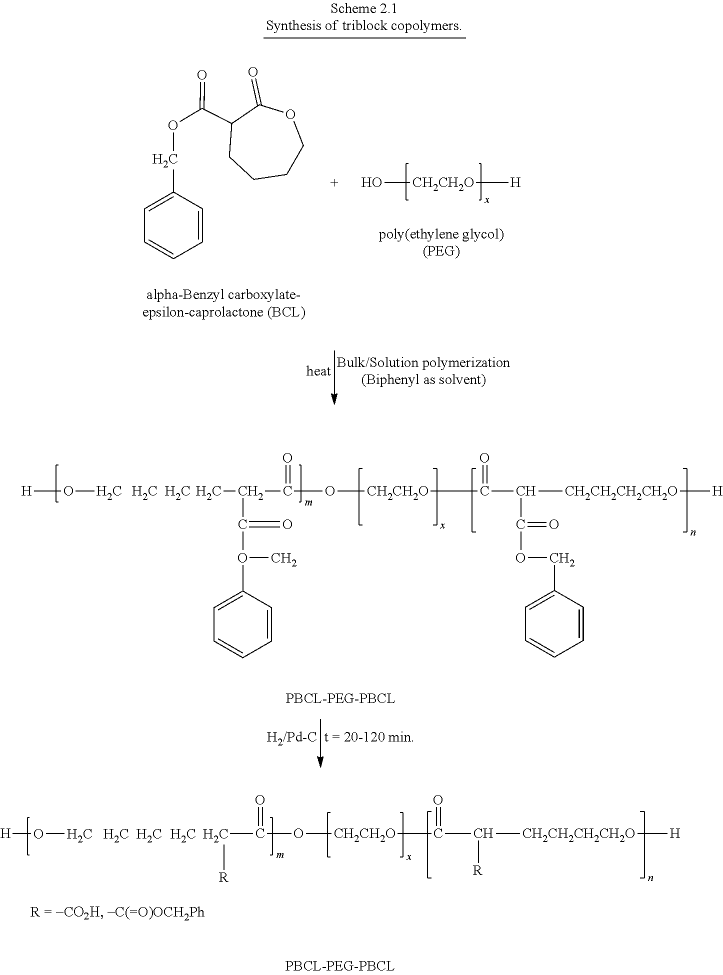

TABLE 2.1
Characteristic of PBCL-PEG-PBCL triblock copolymer synthesized by bulk
polymerization (B₀) and its reduction to PCBCL-PEG-PCBCL at different reduction times (n = 1).

| Sample^{a} | DP | Percent of reduction | Theoretical MW | Mₙ (NMR) | Mₙ (GPC) | $\frac{Mn ( GPC )}{Mn ( NMR )}$ | M_{w} (g/mol) | Ð_{M} | α^{b} | K_{b} (dl/g) |
|---|---|---|---|---|---|---|---|---|---|---|
| B₀ | 12.7 | NA | 5910 | 4620 | 37000 | 8 | 69700 | 1.88 | 0.82 | 0.0000126 |
| B₂₀ | 12.7 | 20 | 5580 | 4430 | 30800 | 6.7 | 64800 | 2.10 | 0.94 | 0.0000056 |
| B₄₀ | 12.6 | 48 | 5110 | 4000 | 28400 | 6.6 | 63600 | 2.24 | 0.73 | 0.0000916 |
| B₆₀ | 12.8 | 64 | 4845 | 3810 | 23200 | 5.8 | 60200 | 2.60 | 0.80 | 0.0000298 |
| B₁₂₀ | 13 | 80 | 4575 | 3700 | 19900 | 5.2 | 55400 | 2.78 | 0.49 | 0.0008531 |

^{a}subscript number shows reduction time.
^{b}Mark-Houwink parameters.

A similar effect was observed for the “S” series, where a positive linear relationship (r² of 0.92) between the time of reduction and the percentage of debenzylation was noted (FIG. 2.1B). The average Mₙ and M_{w} of polymer populations in the “S” series also decreased linearly with an increase in the debenzylation time (r²=0.98 and 0.90 for Mₙ and M_{w}, respectively) (FIG. 2.1D). The linear reduction in polymer molecular weights as a function of reduction reaction time and degree implies the lack of back-biting, chain- or cross-link cleavage during the reduction of PBCL-PEG-PBCL_{PC} under experimental conditions.

TABLE 2.2
Characteristic of PBCL-PEG-PBCL triblock copolymer synthesized by solution
polymerization (S₀) and its reduction to PCBCL-PEG-PCBCL at different reduction times (n = 1).

| Sample^{a} | DP | Percent of reduction | Theoretical MW | Mₙ (NMR) | Mₙ (GPC) | $\frac{Mn ( GPC )}{Mn ( NMR )}$ | M_{w} (g/mol) | Ð_{M} | α_{b} | K^{b} (dl/g) |
|---|---|---|---|---|---|---|---|---|---|---|
| S₀ | 14 | NA | 5910 | 4920 | 47600 | 9.4 | 71300 | 1.50 | 0.82 | 0.000033 |
| S₂₀ | 14.4 | 20 | 5580 | 4750 | 41230 | 8.7 | 65760 | 1.59 | 1.09 | 0.000007 |
| S₄₀ | 14.41 | 35 | 5345 | 4560 | 37830 | 8.3 | 62600 | 1.66 | 0.76 | 0.000229 |
| S₆₀ | 14.31 | 45 | 5180 | 4370 | 30700 | 7.1 | 56900 | 1.85 | 0.80 | 0.000037 |
| S₁₂₀ | 14.41 | 60 | 4910 | 4220 | 21150 | 5.1 | 53300 | 2.5 | 0.36 | 0.005649 |

^{a}subscript number shows reduction time.
^{b}Mark-Houwink parameters.

FIG. 2.2A shows the GPC profile of copolymers prepared by reduction of B₀ at different levels using RI detector. Similar to the B₀ sample, the GPC elution profile of its reduced forms are bimodal and broad, indicating a wide molecular weight distribution. The elution peak at the lower retention time (peak 1) showed 42% mole concentration of large molecular weight population for the B₀ sample, which meets the requirement for producing a thermogel.

The RI signal intensity depends on the concentration and the refractive index increment (dn/dc), in concentration normalized peak, the RI signal area is an indication of dn/dc value. It is worth noting that dn/dc is an essential parameter associated with the MW, size, shape, and concentration of polymers for several analytical techniques based on optical measurement. Based on collected data from the GPC instrument (Table 2.1 and FIG. 2.2A) it can be found that in constant temperature, with a decrease of MW of copolymers because of increase in debenzylation, the value of dn/dc also decreased for copolymers under study.

The molecular weight distribution (MWD) is an important factor that can affect different characteristics of the polymers and their self-assembled structures. The Ð_{M} was enhanced for all PCBCL-PEG-PCBCL_{PC} copolymers under study as the degree of debenzylation in the polymers was raised. This happened irrespective of the PBCL-PEG-PBCL_{PC} method of preparation (B₀ in Table 2.1 or S₀ in Table 2.2). This was expected and reflected the randomness of the debenzylation process. In general, the polydispersity of reduced polymers in the B series (Table 2.1) was higher than that from the S series (Table 2.2), as B₀ itself has shown higher polydispersity compared to that of S₀. Again, this was expected due to lower reaction content viscosity, and higher molecular motions leading to the formation of more uniform populations in the solution polymerization products (S series) compared to the bulk polymerization ones (B series). From FIG. 2.2B, it is evident that the MWD of the B₁₂₀ has skewed to the lower molecular weight area because of the high percentage of debenzylation.

The GPC profile of “S” copolymers as detected by RI showed a bimodal shape, as well, pointing to the presence of a partially cross-linked polymer with 51% mole concentration of high molecular weight population (FIG. 2.2C). However, compared to the GPC profile for the “B” polymers, the elusion profile of “S” polymers was narrower, reflecting a lower polydispersity index of “S” compared to “B” polymers due to the use of solution rather than bulk polymerization in the preparation of S₀ (Table 2.2).Similar to the observation for the B₁₂₀, the S₁₂₀ showed the lowest do/dc and shifted to a lower MW area in the MWD graph (FIG. 2.2C and FIG. 2.2D).

The GPC profile of the “B” copolymers based on the viscometer detector response is shown in FIG. 2.3A. Again, like the RI response, presence of bimodal polymer distribution is obvious here. Viscosity of polymers is related to their molar mass and interaction with solvent through the Mark-Houwink-Sakurada (MHS) equation. With an increase in the debenzylation percentage from 0 to 64% in the “B” copolymers, the viscometer signal area increased. But the B₁₂₀polymer with around 80% debenzylation showed a drastically lowered detector response. The GPC elution profile of the “S” series copolymers based on viscometer detector (FIG. 2.3B) and extracted data from GPC (Table 2.4) disclosed the lowest viscometer detector response and subsequently, viscosity belongs to S₁₂₀ sample, while average intrinsic viscosity increased by reduction time from 0 to 60 min.

The Mark-Houwink-Sakurada (MHS) equation (1) was then used to get an understanding of the polymers' molecular structure and conformation as related to these data. This equation explains the correlation of intrinsic viscosity and molecular weights from the experimental data:

[η]=kM^{α} log [η]=log K+α log [M] (1)

Where α and K are constants depending upon the polymer type, solvent, and temperature of the viscometer detector and correspond, respectively, to the slope and intercept of the double logarithmic plot of molecular weight versus intrinsic viscosity. While α=˜0.5-0.8 is expected for random coil polymer in a good solvent, α increases with an increase in the chain stiffness, and α<0.5 is related to the rigid sphere structure. The MHS parameters for “B” polymers are shown in Table 2.3. The exponent α value of 0.73, 0.71,0.52 and 0.51 for B₀, B₂₀, B₄₀ and B₆₀ was obtained, respectively, which confirmed that these copolymers exist as a random coil conformation in THF at 30° C. Whereas the exponent value for B₁₂₀ was 0.42. Thus, the exponent value of B₁₂₀ exhibited that the conformational structure was a spherical shape. Most likely, carboxylic acids along with the copolymer backbone attributed to creating spherical conformation due to the intermolecular hydrogen bonds between the COOHs of a copolymer chain. Also, the data revealed that S₀, S₂₀, S₄₀, and S₆₀ have random coil conformation and S₁₂₀ exhibited spherical shape conformation in THF at 30° C. (Table 2.4).

There are 2 common measurements of the molecular size based on GPC data: hydrodynamic radius (Rₕ) and radius of gyration (R_{g}). The Rₕ of the sample is the radius of a hypothetical sphere that owns the same mass and density that is calculated for the sample based on molecular weight and intrinsic viscosity. The relationship between Rₕ, M, and [η] is shown in equation (2) (N_{A} is Avogadro's number). Also, R_{g} represents the distribution of mass center in the molecule and calculate based on light scatter detector response. The relationship between Rₕ and R_{g} depends on the molecular structure and for copolymers under study R_{g} was bigger than Rₕ irrespective of methods of polymerization. The average Rₕ and R_{g} for “B” and “S” series copolymers are shown in Table 2.3 and Table 2.4 respectively. like “B” block copolymers, in reduced copolymers from S₀, the average of R_{g} and Rₕ increased by reduction time.

$$[ η ] M = \frac{10 π {N}_{A}}{3} \cdot {R}_{h}^{3} \qquad ( 2 )$$

TABLE 2.3
Characteristics of t copolymers synthesized
by bulk polymerization from GPC.

| | Mol | | | | | |
|---|---|---|---|---|---|---|
| | percentage | | | | | |
| | of PBCL | | | | Rₕ | R_{g} |
| Sample¹ | reduction | IV(dL/g) | α² | K^{b}(dL/g) | (nm) | (nm) |
| B₀ | 0 | 0.14 | 0.73 | 4.44 × 10⁻⁵ | 7.04 | 10.11 |
| B₂₀ | 20 | 0.15 | 0.71 | 6.68 × 10⁻⁵ | 7.05 | 10.16 |
| B₄₀ | 48 | 0.16 | 0.52 | 56.94 × 10⁻⁵ | 7.30 | 10.51 |
| B₆₀ | 64 | 0.20 | 0.51 | 85.58 × 10⁻⁵ | 7.46 | 10.75 |
| B₁₂₀ | 80 | 0.17 | 0.42 | 331 × 10⁻⁵ | 7.76 | 11.18 |

¹B stands for Bulk polymerization. The number in the subscript shows a reduction reaction time in minutes.
²Mark-Houwink parameters.

Thermo-responsive behaviour of the aqueous solution of block copolymers. under study was investigated through small amplitude oscillatory shear rheology and vial inversion test (inverse flow method). The change of storage modulus (G′), loss modulus (G″) and complex viscosity (η) as a function of temperature for an aqueous solution of “B” copolymers at 10 and 15 wt % concentration is shown in FIGS. 2.4. B₂₀ and B₁₂₀ samples showed the behaviour of viscoelastic liquids, where G″ dominate G′ in all temperature (10-50° C.). The B₀, B₄₀, and B₆₀ samples, on the other hand, showed a distinct thermogelling behaviour with the sol-to-gel transition around 34, 24, and 27° C. respectively, at 10 Wt %, as evidenced by the crossover of the G′ and G″ graphs and drastic increase in η* graph (FIG. 2.4A).

TABLE 2.4
Characteristics of copolymers synthesized
by solution polymerization from GPC.

| | Mol | | | | | |
|---|---|---|---|---|---|---|
| | percentage | | | | | |
| | of PBCL | | | | Rₕ | R_{g} |
| Sample¹ | reduction | IV(dL/g) | α² | K^{b}(dL/g) | (nm) | (nm) |
| S₀ | 0 | 0.34 | 0.71 | 30.11 × 10⁻⁵ | 7.08 | 9.55 |
| S₂₀ | 20 | 0.40 | 0.62 | 84.30 × 10⁻⁵ | 7.11 | 9.59 |
| S₄₀ | 35 | 0.41 | 0.60 | 107.23 × 10⁻⁵ | 7.17 | 9.68 |
| S₆₀ | 52 | 0.42 | 0.56 | 157.37 × 10⁻⁵ | 7.34 | 9.91 |
| S₁₂₀ | 72 | 0.26 | 0.47 | 204.97 × 10⁻⁵ | 7.72 | 10.42 |

¹B stands for Bulk polymerization. The number in the subscript shows a reduction reaction time in minutes.
²Mark-Houwink parameters.

Subsequently, we increased the concentration of B₀, B₄₀, and B₆₀ solution to 15 wt % (FIG. 2.4B) and noticed thermo reversible sol-gel behaviour for these samples where the transition temperatures were lowered to 23, 17, and 19° C., respectively. The lowered transition temperature can be attributed to a higher chance of polymer chain interaction and/or micellar aggregation at higher concentrations. Also, the gel window in 15wt % polymer concentration was broader compared to 10 wt % samples. By increasing the concentration of polymer solution, moduli of copolymers significantly increased indicating better mechanical stability of gel at this concentration. Among B samples under study, B₄₀ showed higher moduli and viscosity compared to B₀ and B₆₀ (FIG. 2.4B).

The temperature dependant phase transition behaviour of the aqueous solution of B₀, B₄₀, and B₆₀ at various polymer concentrations (10, 15, and 20 wt %) determined by the inverse flow method is shown in FIG. 2.4C. The B₀ at 10 wt % polymer concentration formed gel at 34° C. (lower transition temperature), as temperature raised to 36° C., a turbid solution was achieved (upper transition temperature). By raising polymer concentration from 10 to 15 and 20 wt %, lower transition temperate declined from 34° C. to 30 and 25° C. respectively. On the other hand, upper transition temperature for B₀ increased to 38 and 40° C. by elevating polymer concentration. Similar behaviour was observed for B₄₀ and B₆₀ and gel window became broader by increasing of polymer concentration.

The thermo-responsive behaviour of “S” copolymers at different concentrations is shown in FIG. 2.5. The S₀ sample had very low sol-to-gel transition (around 10° C.) at all concentrations under study (where G′ dominate G″). At 15% polymer concentration, this sample showed thermo-reversible behaviour with a sol-to-gel transition around 12° C. and gel-to-sol transition around 40° C. (FIG. 2.5B). The S₂₀ polymer did not show thermogelling behaviour at different concentrations under study, while there is the cross over of G′ and G″ modulus at 10 wt % for S₂₀, there is no rise in η* that confirm critical gel point for this sample. Rheology test revealed S₄₀ has the sol-to-gel transition of 24° C. and 22° C. at 10 and 15wt % respectively, while the inverse flow method showed higher transition temperature for this sample (36° C. and 34° C. for 10 and 15 wt %). The inverse flow method showed the S₆₀ sample has a lower transition temperature of 22, 20 and 18° C. for 10, 15 and 20 wt % polymer concentrations, respectively. The upper transition temperature for this sample was 32, 37 and 38° C. at above concentrations, respectively, which confirmed rheology results. Although S₁₂₀ showed the peak at around 16° C. for 10 wt %, but this sample didn't show thermo-reversible behaviour in concentration under study based on inverse flow test.

All copolymers under study (B and S series) can be self-assembled at ambient temperature in water. FIG. 2.6 shows the negative correlation between the aggregate size and percentage of debenzylation or reduction time regardless of the method of polymerization. Indeed, by increasing debenzylation time from 0 to 120 min for the “B” series, the aggregate size decreased gradually from 136 nm to 68.5 nm, this increment is more significant for the “S” series while the aggregate size of S₀ (295 nm) was declined to 68.5 nm for S₁₂₀.

The copolymers herein self-assemble into micelle in water, but reverse thermogelling is a more complex process for these copolymers. Some models of gelation, include micelle aggregation, micelle bridging and a percolated micelle network. One possible mode of gelation of the copolymers in water follow the percolated micelle network model: at low temperatures, the copolymers can self-assemble to micelles with core-corona structure, and by increasing the temperature, the corona of micelles collapses due to reverse thermosensitivity of PEG; if the corona becomes sufficiently thin, it may not cover the hydrophobic core and form semi-bare or semi-bald micelles. Owing to the hydrophobicity of the micellar core, hydrophobic interaction occurs which promotes aggregation of micelles. To explain the gelation behaviour of various copolymers under study, we focus on specifications of the hydrophobic part since PEG as middle block of triblock is constant for copolymers and generated by the PEG 1450 Da as an initiator. B₀, B₄₀, and B₆₀ exhibited thermo-responsive behaviour, while B₂₀ and B₁₂₀ did not show thermo-responsive behaviour. The ratio of —COOH and Ph-CH₂—OOC— functional groups in the caprolactone blocks can explain the action of reduced copolymers. The debenzylation process decreases molecular weight of copolymers (Table 2.1 and Table 2.2), then it has a negative effect on aggregation of semi-bald micelles. Whereas the —COOH serve as hydrogen bond donors which facilitate inter and intra-polymer chain interactions in aqueous media. It is possible that B₂₀ and B₁₂₀ effect of hydrogen bonding could not compensate the negative effect of molecular weight reduction during debenzylation. For the “S” series copolymers a similar trend was observed, while S₀, S₄₀ and S₆₀ showed reversed thermogelling and S₂₀. S₁₂₀ were solution at all temperatures.

### Example 3. Triblock Copolymers Using Pure Monomers

### 1. Introduction

The bulk polymerization of pure BCL using PEG as cross-linker was optimized using two molecular weight of the PEG (200 and 400) and different molar ratios of cross-linker to monomer, while other parameters such as ratio of monomer to PEG 1450 (as initiator), polymerization reaction time, and temperature were kept constant.

2. Materials and Methods 2.1. Materials. Extra pure α-benzyl carboxylate-ε-caprolactone (BCL) was synthesized by Alberta Research Chemicals Inc (ARCI), Edmonton, Canada. Purification of BCL was accomplished through serial column purifications via dichloromethane and ethyl acetate/hexane system. Then trituration was carried out with hexane and heptane several times to get white, solid, and extra pure powder of BCL. Dihydroxy (PEG) (Mw=200, 400 and 1450 Da), polycaprolactone triol (Mₙ=300 Da), trimethylolpropane ethoxylate (Mₙ=170 Da) and solvents such as tetrahydrofuran (THF), dichloromethane (DCM) and hexane (chemical reagent grade) were purchased from Sigma-Aldrich (St. Louis, Mo.).

2.2. Synthesis of triblock copolymers using pure monomer. Synthesis of triblock copolymer (ABA) was accomplished through ring opening polymerization of pure monomer (BCL) and PEG. In brief, first BCL (0.6 g) and PEG (0.19 g) were dehydrated in vacuum oven at 70° C. for 3 h. The polymerization reaction was conducted at 160° C. in an ampule sealed under vacuum for 10-40 h according to conditions described in Table 3.1. Prepared triblock copolymers were purified by dissolving the products in tetrahydrofuran (THF), followed by precipitation using anhydrous ethyl ether. The sediment was dried under vacuum for 24 h.

2.3. Cross-linking of triblock copolymers by different polyols. Low molecular weight PEGs, i.e., dihydroxy PEG200 and 400 Da, PCL-triol, or TMP ethoxylate were used as cross-linker for the prepared triblock copolymers. In this procedure, bulk polymerization of the pure monomer by PEG (Mw=1450 Da) was accomplished at 160° C. for 23 h. This was followed by the purification of polymers by THF-ethyl ether. Different molar ratios of BCL units in the block copolymer to cross-linker (as summarized in Table 3.2 and Table 3.3) were dissolved in 500 μL of dichloromethane and added into a break-seal ampule containing 500 mg of triblock polymer solution in 500 μL dichloromethane. The ampule was kept in a vacuum oven at 50° C. for 2 h and at ambient temperature overnight to evaporate DCM. After, the ampule was sealed again under vacuum and left for 4 h at 160° C. in the oven for the nucleophilic reaction of the cross-linker with the PBCL backbone to proceed. Prepared copolymers were purified by dissolving the product in THF and precipitation using anhydrous ethyl ether. The final product was dried under a vacuum for 24 h (Scheme 3.2).

### 2.4. Characterization of Triblock Copolymers and Hydrogels

2.4.1. Nuclear Magnetic Resonance (NMR) spectroscopy. Polymers were dissolved in CDCl₃ at a concentration of 5 mg/mL, then ¹H NMR spectra were recorded using a Bruker Avance III HD 600 MHz. The degree of polymerization (DP) and number average molecular weight (Mₙ) of block copolymers were calculated by comparing the area under the peak of methylene protons of the PEG block (CH₂CH₂O—, δ=3.65 ppm) to the methylene protons of the PBCL backbone (—OCH₂—, δ=4.1 ppm). The Mₙ of the PEG block was considered as 1450 g/mol for these calculations.

2.4.2. Gel permeation chromatography (GPC). Agilent 1260 Infinity II Multi-Detector GPC/SEC system with 3 detectors (Refractive index (RI), light scatter (LS) and viscometer (VS)) was used to obtain data on the peak maximum retention time (PMRT), average molecular weights (MW) and molar-mass dispersity (Ð_{M}) of the prepared block copolymers. The GPC instrument was equipped with 2 columns (styragel HR2 and styragel HR 4E from waters company) and calibrated with a set of polystyrene standards covering a molecular weight range of 160-200,000 g/mol. Samples (5-10 mg/mL) were prepared in THF (HPLC grade) and filtered with a nylon syringe filter (pore size: 0.45 μm). Then 200 μL of samples were injected into GPC which was operated at a THF flow rate of 0.7 mL/min at 35° C.

2.4.3. Phase diagram by inverse flow method. The gelation behaviour was evaluated by the inverse flow method at a concentration of 150 mg/mL of polymer in water. The vial containing 1 ml of copolymer solution was equilibrated at 4° C. overnight before the test. Then the vial was immersed in a water bath at 30° C. and equilibrated for 15 min. If the content of the vial did not flow for 30 s, the sample was considered a gel.

2.4.4. Rheological testing. The rheology test was performed on a Discovery Hybrid Rheometer (TA instruments) in parallel plate geometry with a diameter of 40 mm and an auto gap set mechanism. The copolymer solutions in water (concentration 15 wt %) were prepared and equilibrated at 4° C. overnight. A temperature ramp test was performed to investigate the viscoelastic property changes of hydrogels as a function of an increase in temperature. For temperature ramp, the test was conducted at a strain of 2% (within their linear viscoelastic regions (LVR)), angular frequency (ω) of 10 rad/s and heating rate of 1° C./min from 10 to 50° C.

2.5. Characterization of the self-assembly of copolymers by DLS. The self-assembly of copolymers was characterized using MALVERN Nano-ZS90 ZETA-SIZER (Malvern Instruments Ltd, Malvern, UK). For sample preparation, 10 mg of the copolymer sample was dissolved in 1 mL of acetone then 10 mL of distilled water was added to this solution dropwise. The mixture was stirred for 24 hours at room temperature to evaporate acetone. The diameter of self-assembled structures was determined with a Zetasizer Nano equipped laser at a wavelength of 633 nm using intensity function. The scattered light was detected at an angle of 173°.

### 3. Results

3.1. Characterize the effect of polymerization time on the molecular weight and molecular weight distribution of block copolymers synthesized by pure monomer.

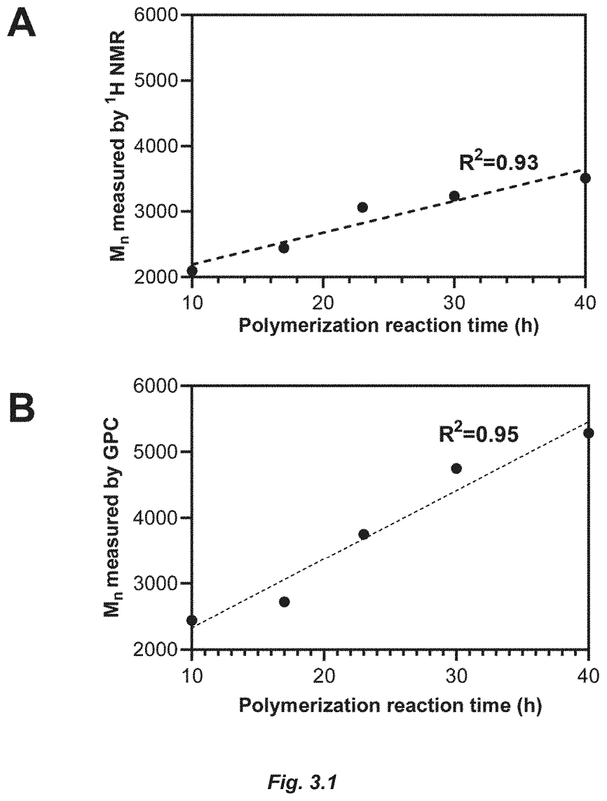

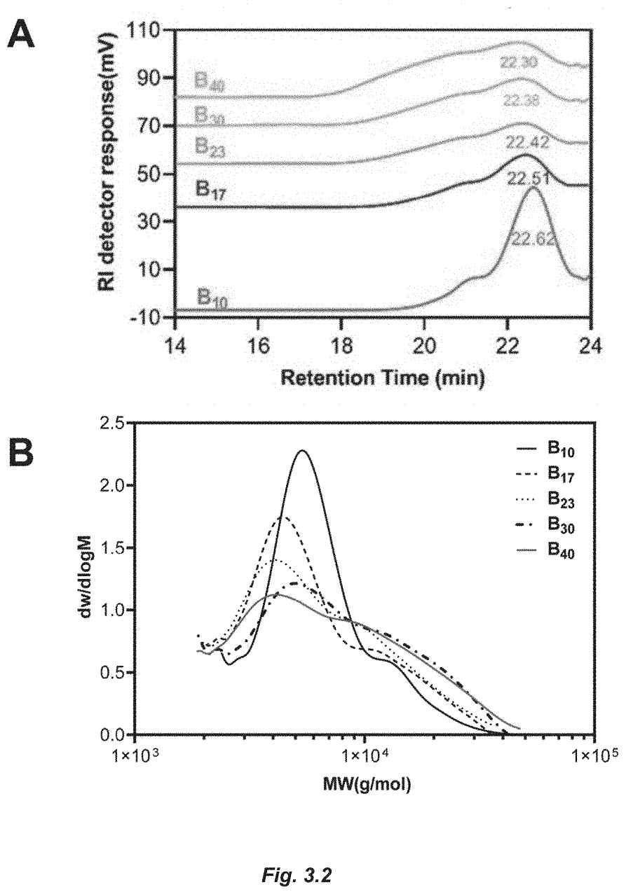

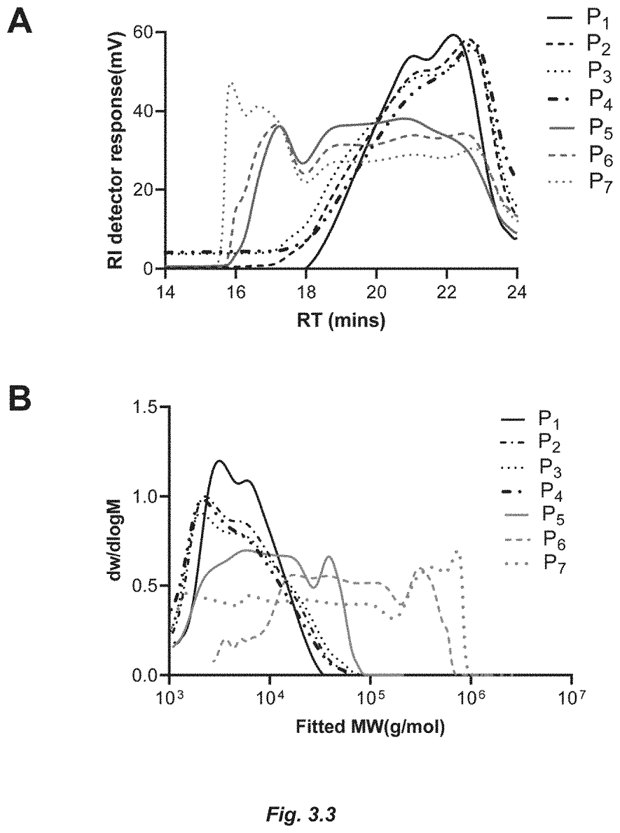

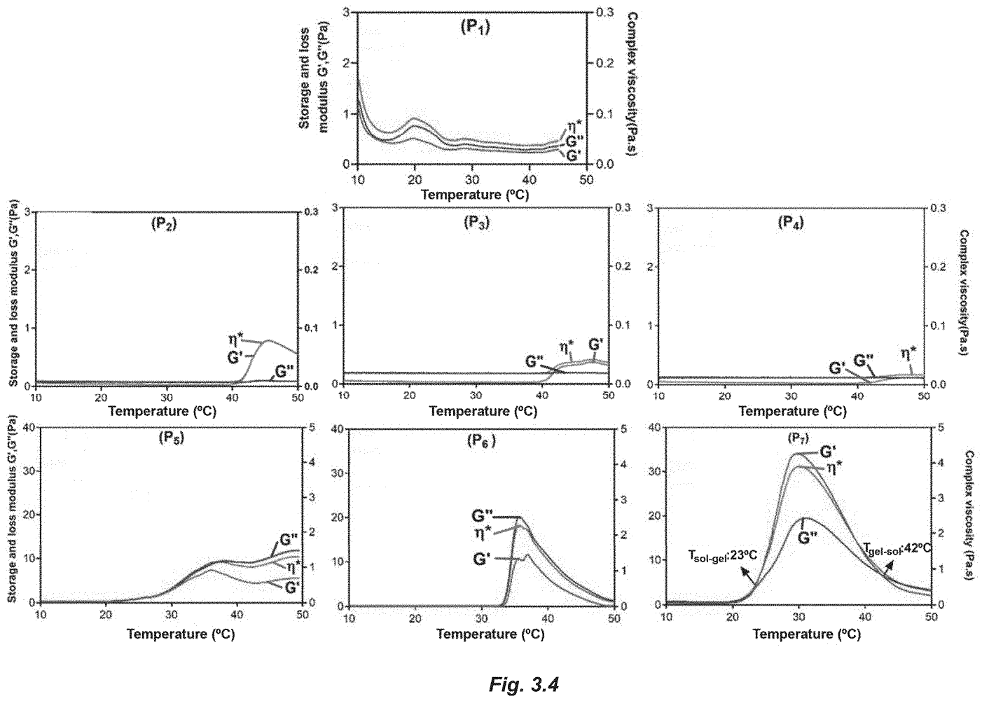

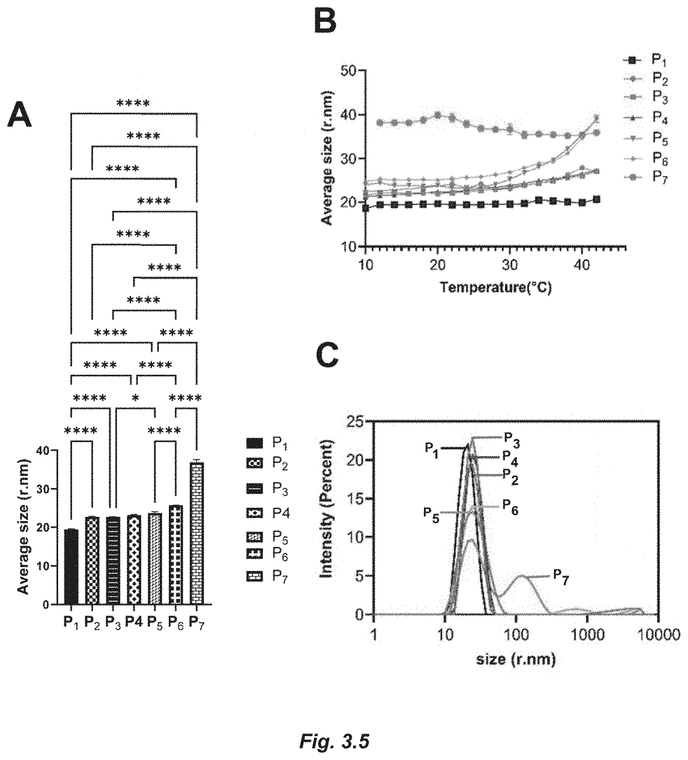

As a potential source for the accidental cross-linking in the polymerization of BCL by PEG was the impurities in the monomer, here, we used purified BCL. Polymerization of purified BCL initiated by PEG (1450 Da) at different polymerization times (10-40 hours) (Table 3.1). As shown in FIG. 3.1A & FIG. 3.1 B, the increase in the reaction times showed a positive and linear correlation with the Mₙ (as measured by ¹H NMR and GPC respectively) of the prepared copolymers. However, even at the maximum reaction time (40 h), DP and Mₙ (NMR) of the product (8.3 and 3508, respectively) (Table 3.1) were significantly lower than that of the expected theoretical values (18 and 6000 g/mol for DP and Mn, respectively). In the current study, the calculated weight average molecular weight (M_{w}) for B₄₀, was 8866 g/mol. This was only 1.5-fold higher than the theoretical average molecular weight for this sample. This indicates the linear growth of the PBCL chain over time and the absence of any significant proportion of branched/crosslinked structure in the product. In line with this explanation, the highest Mₙ (GPC)/Mₙ (NMR) ratio measured for PBCL-PEG-PBCL polymers prepared using purified BCL was 1.50 (Table 3.1). However, the formation of thermo-reversible gels in aqueous media for the synthesized PBCL-PEG-PBCLs was only observed in polymer samples with Mₙ (GPC)/Mₙ (NMR)≥6.

By increasing the polymerization time, the GPC elution profiles of synthesized copolymers (FIG. 3.2A) showed a decrease in the peak's maximum retention time reflecting an increase in the molecular weights of copolymers. The molecular weight distribution (MWD) of polymers resulting from GPC chromatograms (FIG. 3.2B) revealed a similar general shape for all polymers under study, but the weight fraction of the lower molar mass chains slightly decreased as the reaction time progressed. By increasing the polymerization time, the MWD graph of samples skewed to the higher molecular weight area, leading to an increase of polydispersity index (Ð_{M}) (Table 3.1). All the PBCL-PEG-PBCL polymers prepared using the pure monomer (B₁₀-B₄₀) were water-soluble at a concentration of 15 wt % and 30° C. and did not form a visual gel under this condition, as judged by the inverse flow method (Table 3.1). The collection of the above evidence indicated bulk polymerization of extra pure BCL initiated PEG even in high polymerization time lacked the higher-than-expected molecular weight population observed for the impure BCL in previous studies, thus, did not produce thermo-reversible hydrogels in water.

TABLE 3.1
Characteristic of synthesized triblock copolymers with pure monomer and bulk method
(theoretical MW of copolymers is 6000 g/mol).

| | | | | | | | Appearance |
|---|---|---|---|---|---|---|---|
| Sample¹ | DP² | Mₙ (NMR) | Mₙ (GPC) | $\frac{Mn ( GPC )}{Mn ( NMR )}$ | Mw (g/mol) | Ð_{M} | in water at 30° C. |
| B₁₀ | 2.6 | 2095 | 2440 | 1.16 | 3433 | 1.41 | Sol |
| B₁₇ | 4 | 2442 | 2720 | 1.11 | 3994 | 1.47 | Sol |
| B₂₃ | 6.5 | 3062 | 3751 | 1.23 | 6104 | 1.62 | Sol |
| B₃₀ | 7.2 | 3236 | 4747 | 1.47 | 7813 | 1.65 | Sol |
| B₄₀ | 8.3 | 3508 | 5285 | 1.50 | 8866 | 1.68 | Sol |

¹B stands for Bulk polymerization and the number in the subscript shows the reaction time in hours.
²Degree of polymerization (DP) of PBCL block measured by ¹H NMR.

3.2. Characterization of block copolymers synthesized via different cross-linkers.

To investigate the effect of cross-linkers on the characteristics of produced polymers thermogel formation, B23 sample, with a middle MW among synthesized copolymers was selected. Covalent cross-linking of the PBCL-PEG-PBCL was chosen to assess the potential of this approach in producing a reproducible process for the formation of a viscoelastic thermo-gel. For this purpose, three different cross-linkers bearing multi-functional hydroxyl groups in their structure, i.e., PEG 400, polycaprolactone triol, and trimethylolpropane ethoxylate were used at a cross-linker: monomer molar ratio of 4:10 (Scheme 3.1). Table 3.2 shows characteristics of chemically cross-linked B₂₃ by different cross-linkers. ¹H NMR spectra of the products showed similar DP and Mₙ for the products of B₂₃ reaction with either of the three cross-linkers. Data from GPC showed Mₙ, M_{w}, and D_{M} of the products to be similar, irrespective of the type of cross-linker used, as well. The Mₙ (GPC)/Mₙ (NMR) ratio was 1.23 for the starting B₂₃ polymer. Hence, B₂₃ was considered a linear copolymer. The ratio of Mₙ (GPC)/Mₙ (NMR) for B₂₃ after reaction with either of the three cross-linkers was shown around 8.5, which was around 7 folds larger than that of linear B₂₃.

This implied success in partial cross-linking of PBCL-PEG-PBCL irrespective of the cross-linker type. The proposed mechanism for the reaction between the polyol cross-linkers and the PBCL backbone is shown in Scheme 3.2.

A nucleophilic acyl substitution reaction between the benzyl carboxylate pendant group of the polymer backbone and the hydroxyl groups of cross-linkers was assumed to take place in the reaction.

Although the Mₙ (GPC)/Mₙ (NMR) ratio for the products of PCL-triol and TMP ethoxylate cross-linkers implied the success of cross-linking reactions, only the product with PEG 400 as the cross-linker showed thermo-gelling behavior in water at 30° C. The molecular architecture of the final products prepared through the addition of PCL-triol and TMP cross-linkers with three hydroxyl groups (three-point attachment to the backbone), may cause restriction in the freedom of conformations of the polymer backbone. This can hamper the thermal gelation of the product. The difference in the hydrophilicity of the PCL-triol and TMP versus PEG may have contributed to this observation, as well.

TABLE 3.2
Characteristic of triblock copolymers synthesized by pure monomer and different
cross-linkers with molar ratio (cross-linker/monomer) of 4/10.

| | | | | | | | | Appearance |
|---|---|---|---|---|---|---|---|---|
| Sample | Cross-linker | DP | Mₙ (NMR) | Mₙ (GPC) | $\frac{Mn ( GPC )}{Mn ( NMR )}$ | M_{w} (g/mol) | Ð_{M} | in water at 30° C. |
| B₁ | Polyethylene glycol | 13 | 4670 | 39700 | 8.50 | 42500 | 1.07 | gel |
| B₂ | Polycaprolactone triol | 12 | 4430 | 38750 | 8.75 | 46300 | 1.19 | sol |
| B₃ | Trimethylolpropane | 13 | 4674 | 40065 | 8.57 | 44493 | 1.11 | sol |
| | ethoxylate | | | | | | | |

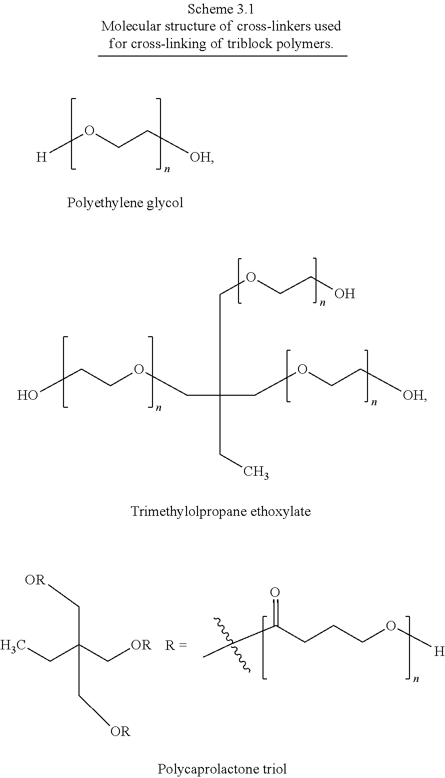

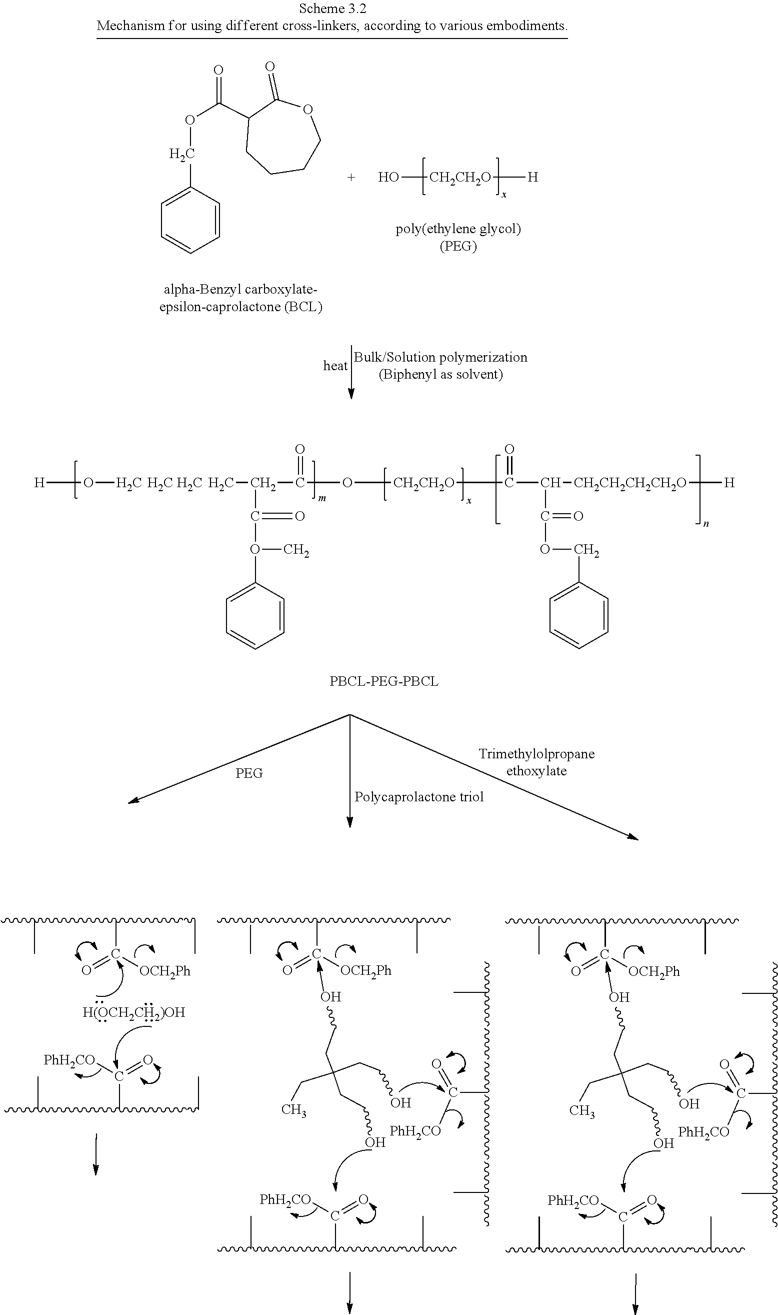

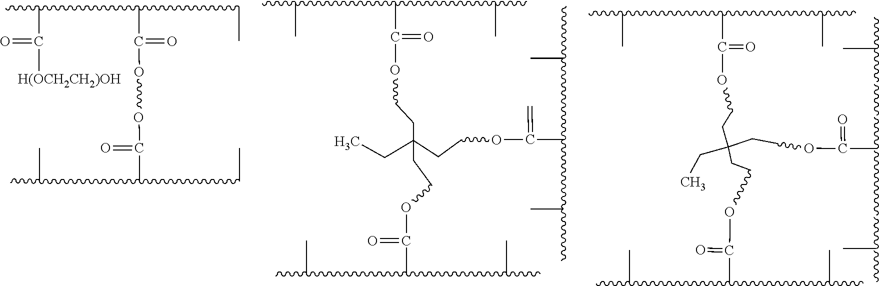

3.3. The effect of PEG molecular weight and molar ratio on the characteristic and gelation of synthesized copolymers.

To further investigate the effect of cross-linker, PEGs with different molecular weights (200 and 400 Da) at different molar ratios to the BCL unit in the PBCL block were reacted with PBCL-PEG-PBCL as detailed in Table 3.3. Assessing the characteristics of the prepared copolymers from the ¹H NMR spectra showed a similar degree of polymerization and Mₙ for all products (P₁ to P₇ in Table 3.3). The GPC elution profiles of P₁-P₇ in THF are shown in FIG. 3.3A and related data are summarized in Table 3.3. For the P1 polymer where no cross-linker was used, the peak maximum retention time (PMRT) was recorded at 22.20 min.

The data showed increasing the molar ratio of PEG 200:BCL unit, to lead to an increasing trend in the peak with maximum retention time (PMRT) of produced copolymers from 22.62 to 22.76 min. In contrast, when PEG 400 was used as the cross-linker increasing the molar ratio of PEG to that of the BCL unit, led to a decline in PMRT of product from 20.80 for P₅ to 17.18 for P₆ and 15.86 for P₇. As shown in FIG. 3.3B and Table 3.3, polymers prepared using PEG 400 as cross-linker, at a 2:10 and 4:10 PEG:BCL molar ratio, had a distinct population with drastically increased molecular weights. In these samples, the Mₙ (GPC)/Mₙ (NMR) ratio abruptly raised to 6.60 and 8.98, respectively. For P₅ polymer with a PEG 400:BCL molar ratio of 1:10, the Mₙ (GPC)/Mₙ (NMR) ratio (2.73) was still higher than the corresponding sample prepared using PEG200 (1.04). Also, the calculated weight average molecular weight (M_{w}) for P₅, P₆, and P₇ were 36023, 98050, and 185000 g/mol which is 6, 16, and 31-fold higher than the theoretical molecular weight of these samples. Meanwhile, the Inverse flow test at 30° C. for an aqueous solution of samples under study at 15% wt concentration revealed only P₆ can produce a thermo-reversible gel.

TABLE 3.3
Characteristic of synthesized triblock copolymers by pure monomer and different ratio
of crosslinker (PEG 200, 400) to monomer (theoretical MW of copolymers was 6030 g/mol).

| | | Molar ratio | | | | | | | Appearance |
|---|---|---|---|---|---|---|---|---|---|
| Sample | Cross- linker | Cross-linker/ monomer | DP | Mₙ (NMR) | PMRT (min) | Mₙ (GPC) | $\frac{{M}_{n} ( GPC )}{{M}_{n} ( NMR )}$ | M_{w} (g/mol) | in water at 30° C. |
| P₁ | PEG 200 | 1/10 | 6 | 2938 | 22.62 | 3067 | 1.04 | 6845 | Sol |
| P₂ | PEG 200 | 2/10 | 6.4 | 3037 | 22.71 | 3068 | 1.01 | 7630 | Sol |
| P₃ | PEG 200 | 4/10 | 6.1 | 2963 | 22.76 | 3060 | 1.03 | 6596 | Sol |
| P₄ | PEG 400 | 1/10 | 6.7 | 3112 | 20.80 | 8493 | 2.73 | 36023 | Sol |
| P₅ | PEG 400 | 2/10 | 6 | 2938 | 17.18 | 19400 | 6.60 | 98050 | Sol |
| P₆ | PEG 400 | 4/10 | 6.5 | 3062 | 15.86 | 27500 | 8.98 | 185000 | Gel |
| P₇ | NA | NA | 6 | 2938 | 22.20 | 3925 | 1.33 | 6377 | Sol |

3.3.1. The effect of PEG molecular weight and molar ratio on the viscoelastic properties of copolymer aqueous solutions. Oscillatory rheology was used to probe the temperature dependant viscoelastic properties of the aqueous solution of P₁-P₇ at a concentration of 15 wt % in the temperature range of 10-50° C. (FIG. 3.4). In thermo-gelling materials, storage modulus (G′), loss modulus (G″), and complex viscosity (η*) increase proportionally as a function of temperature. When G′ is over G″, gelation behavior for the aqueous solution of the copolymer is envisioned. For viscoelastic materials, at the sol-gel transition temperature (sol-gel), we expect G′≈G″. Above this temperature G′ stays higher than G″. At gel-sol transition, again G′≈G″ and above this transition G″ stays above G′.

For the triblock copolymer synthesized without the addition of any crosslinker (P₁), G′, G″ and η* showed a peak around 20° C. The peak maximum for the G′ and G″ was 0.50 and 0.76 Pa, respectively and there was no cross over of G′ and G″ for this sample. Polymers synthesized using PEG 200 as cross-linker (P₂, P₃, and P₄) had moduli below 1 Pa. Also, the rise in temperature above 40° C. led to an increase in G′, G″ and η* while G″ was higher than G′ at all temperatures under study. On the other hand, polymers that were reacted with PEG 400 had higher moduli. For these samples, a drastic change in G′, G″ and η* occurred at a specific temperature range. For the P₆ sample, the value of G′, G″ and η* showed a peak after 32° C. but loss modulus still dominated storage modulus indicating viscose behavior for this sample. The P₇ sample showed sol-gel transition at 23° C., which was reflected by a cross-over of G′ and G″. A gel-sol transition was recorded at 42° C. for this polymer, reflected by a second cross-over of G′ and G″.

3.3.2. The effect of PEG molecular weight and molar ratio on temperature-dependent self-assembly of block copolymers in aqueous solutions. The average size of self-assembled structures for P₁-P₇ samples at ambient temperature in the water is shown in FIG. 3.5A. The average size of P₁ aggregate in water was significantly lower than other samples under study. The P₂, P₃, and P₄ aggregates in water showed a similar size. For polymers reacted with different molar ratios of PEG 400 Da, a positive correlation between the aggregate size and the molar ratio of PEG 400:BCL was observed. Remarkably, the P₇ sample produced significantly larger aggregates at room temperature compared to other samples under study. FIG. 3.5B shows the change in the average size of the self-assembled structure for P₁-P₇ as a function of temperature. There was no significant change in the size for P₁-P₄ by raising the temperature from 10° C. to 50° C. while P₅ and P₆ samples showed an increase in micellar size after 28 ° C. The P₇ sample showed a peak around 20° C. and plateaued after. Size distribution of the self-assembled structure of copolymers (P₁-P₇) is shown in FIG. 3.5C. A unimodal distribution with similar intensity was observed for P₁-P₄ while P₅ and P₆ samples showed a bimodal distribution with negligible intensity (≤2%) of the second peak in the size distribution graph. On the other hand, for P₇ sample bimodal size distribution was significant. While the first peak with a Z-average of 32 nm has 68% intensity, the second peak with an average size of 180 nm has 32% intensity at 30° C. This may reflect a bulkier structure for the PBCL block due to the partial cross-linking and/or branching of the PBCL segment by PEG 400 Da, which may not be shielded adequately by the micellar shell.

The data confirmed our hypothesis on the effect of partial cross-linking as a potential mechanism for the formation of thermo-reversible and viscoelastic hydrogels from PBCL-PEG-PBCLs. The results of this study can enrich our understanding of the effect of polymer architecture in PEG/PBCL copolymers on their thermo-gelling behavior.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A copolymer comprising monomer units of an alpha-carboxylate-epsilon-caprolactone (CL) and ethylene glycol (EG).

2. The copolymer of claim 1 wherein the copolymer is a block copolymer comprising poly(CL) and poly(EG).

3. The copolymer of claim 1 wherein the copolymer is a triblock copolymer comprising poly(CL)-poly(EG)-poly(CL).

4. The copolymer of claim 1 wherein the copolymer further comprises a crosslinker that is linked to at least one of the alpha-carboxylate moieties.

5. The copolymer of claim 1 wherein the copolymer is represented by Formula I: 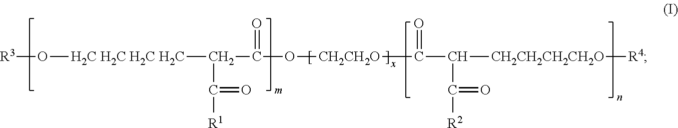
wherein
R¹ and R² are each independently a crosslinker, —OH, —O(C₁-C₆)alkyl, or —OCH₂Ph wherein Ph is optionally substituted;
R³ and R⁴ are terminal groups;
m and n are each independently an integer from 1-50; and
x is an integer from 5-150.

6. The copolymer of claim 5 wherein m and n are each independently an integer from 2 to 30.

7. The copolymer of claim 5 wherein x is an integer from 5 to 50.

8. The copolymer of claim 5 wherein R¹ and R² are —OCH₂Ph.

9. The copolymer of claim 5 wherein R¹ and R² are —OH.

10. The copolymer of claim 5 wherein the crosslinker has at least two heteroatoms that are covalently bonded to the acyl moieties at R¹ and/or R² of Formula I.

11. The copolymer of claim 10 wherein the crosslinker is:
—(OCH₂CH₂)ₐO—;
CH₃CH₂C(CH₂R⁵)₃ wherein R⁵ is —(OCH₂CH₂)_{b}O—; or CH₃CH₂C(CH₂OR⁶)₃ wherein R⁶ is —(C═O(CH₂)₅O)_{c}—;
wherein a, b, and c are each independently an integer from 1 to 100.

12. The copolymer of claim 11 wherein the crosslinker is —(OCH₂CH₂)ₐO—.

13. The copolymer of claim 11 wherein a, b, and c are each independently an integer from 5 to 15.

14. The copolymer of claim 10 wherein R¹ and R² are each independently the crosslinker and —OH.

15. The copolymer of claim 10 wherein R¹ and R² are each independently the crosslinker and —OCH2Ph.

16. The copolymer of claim 5 wherein the number average molecular weight (Mₙ) or weight average molecular weight (M_{w}) is about 1,000 g/mol to about 80,000 g/mol.

17. A viscoelastic or thermo-reversible hydrogel comprising a copolymer according to claim 1.

18. The viscoelastic or thermo-reversible hydrogel of claim 17 comprising about 10 wt. % to about 50 wt. % of the copolymer.

19. A method for forming the copolymer according to claim 1 comprising contacting benzyl 2-oxooxepane-3-carboxylate and polyethylene glycol for a sufficient period of time at above 25° C. to form a copolymer under ring-opening polymerization reaction conditions.

20. The method of claim 19 further comprising at least partially debenzylating the copolymer and crosslinking the at least partially debenzylated copolymer with a crosslinker that comprises at least two primary alcohols.
